(19) United States
(12) Patent Application Publication
(10) Pub. No.: US 2024/0093705 A1
(43) Pub. Date: Mar. 21, 2024

(54) PHONONIC SUBSURFACE FOR CONTROLLING HYPERSONIC FLOW

(71) Applicants: Mahmoud I HUSSEIN, Boulder, CO (US); THE REGENTS OF THE UNIVERSITY OF COLORADO, A BODY CORPORATE, Denver, CO (US)

(72) Inventor: Mahmoud I. HUSSEIN, Boulder, CO (US)

(21) Appl. No.: 18/275,187

(22) PCT Filed: Feb. 2, 2022
(86) PCT No.: PCT/US2022/014978

§ 371 Date: Jul. 31, 2023

Related U.S. Application Data
(60) Provisional application No. 63/144,968, filed on Feb. 2, 2021.

(51) Int. Cl. F15D 1/00; F15D 1/06; F15D 1/12

(52) U.S. Cl. CPC F15D 1/0035; F15D 1/0055; F15D 1/006; F15D 1/0085; F15D 1/06; F15D 1/12

(57) ABSTRACT

A phononic material includes an interface surface and a subsurface feature mechanically connected to the interface surface. When a hypersonic flow having at least one instability flows past the interface surface, the interface surface vibrates in response to one or more frequency components of the pressure. The interface surface couples each frequency component into the subsurface feature, which at least partially reflects and phase-shifts each frequency component to generate a corresponding phase-shifted frequency component. The interface surface vibrates in response to the phase-shifted frequency component, thereby coupling the phase-shifted frequency component back into the hypersonic flow. The phase-shifted frequency component interferes with said each frequency component within the hypersonic flow. The subsurface feature may perform phase-shifting such that the phase-shifted frequency component destructively interferes with said each frequency component, thereby reducing the at least one instability.

### RELATED APPLICATIONS

This application claims priority to U.S. Provisional Patent Application No. 63/144,968, titled “PHONONIC SUBSURFACES FOR THE CONTROL OF HYPERSONIC FLOWS” and filed Feb. 2, 2021, the entirety of which incorporated herein by reference.

### BACKGROUND

The interaction between a fluid and a solid surface in relative motion represents a dynamical process that is central to the problem of laminar-to-turbulent transition (and consequent drag increase) for air, sea and land vehicles, as well as wind turbines, long-range pipelines and other applications. Because skin friction drag is lower in laminar than in turbulent flows, its reduction can potentially be achieved by either delaying laminar-to-turbulent transition, or by controlling and attenuating turbulence and hence reducing wall-shear in fully developed turbulent flows.

The field of flow control may be traced back to prehistoric times when primitive tools and weaponry, such as spears and arrows, had features deliberately included to interact favorably with the surrounding flow. These features emerged by empirical evolution rather than an understanding of the underlying physics. The scientific method for flow control appeared only at the start of the twentieth century with Prandtl's proposition of the boundary layer theory accompanied by an explanation of the physics of flow separation, and a demonstration of several experiments for boundary layer control. Following this seminal contribution, the concept of flow control, especially for wall-bounded flows, emerged as a major research thrust in fluid mechanics and its development progressed over several stages, or eras, in which numerous passive and active approaches have been extensively investigated. These approaches encompass streamline shaping of the surface, surface heating or cooling, injection of polymer additives into the flow, addition of ribs on the surface, suction and blowing and coating of the surface with a compliant material, among others.

Regardless of the approach for stimulating a change in flow behavior, successful intervention may be realized when particular undesirable flow structures and mechanisms are identified and clearly understood. Concerning flow transition and increase in surface (skin friction) drag, the nucleation and growth of unstable disturbances are profoundly detrimental. Owing to their wave nature, the impediment of growth of these disturbances (i.e. their stabilization) is possible and may be induced by wave cancellation or at least a degree of destructive interference. Wave cancellation or superposition has been extensively investigated using active means. Results, however, have been modest especially when applied to complex conditions such as flow transition where primary disturbances give rise to residual disturbances at a variety of frequencies, phases and orientations, which render the control process intractable.

In a wall-bounded flow, there is a mutual dependence between the dynamic behavior of the fluid and the solid. This dependence is shaped by the nature of the fluid-structure interaction at the interface. It is therefore conceivable, in principle, to use the fluid to affect the constitutive response of the solid and, conversely, to favorably alter the ‘character and disposition of a flow field’ by tuning the elastodynamic response of the solid surface. As mentioned above, this latter notion has been explored in the literature by the utilization of surfaces with significantly compliant elastic properties. The concept was introduced in 1957 by Max O. Kramer after conducting an experiment on a motorboat in which a model with a dolphin-like skin was towed in the sea and shown to exhibit a more than 50% reduction in drag. Although this result was later questioned due to lack of well-controlled experimental conditions, it has helped trigger much interest in the subject. Numerous investigations were conducted on the ensuing effects on phenomena as complex as laminar-to-turbulent transition and skin-friction drag. A compliant surface predominantly admits Rayleigh elastic waves along the surface, and due to its low stiffness allows for the possibility of large surface motion and hence significant interaction with the flow. Its main advantage stems from its passivity and simplicity, i.e. no active control devices, wires, ducts and slots, etc. are needed. This is an economically desirable benefit, in fact critical, as the energy consumed in operating active devices may often exceed the energy saved by altering the flow. The concept, however, suffers from several crucial drawbacks. The large wall motion is mostly undesirable as it increases the likelihood of surface instabilities (e.g. flutter). Furthermore, a considerably high compliance is generally not welcome in intense operating environments where load-bearing materials are needed. A more fundamental disadvantage is that there is no clear route to mechanistic tuning for precise frequency- and phase-dependent intervention with the flow.

Turbulence in a flow includes an arrangement of counter-rotating streamwise vortices that are elongated along a streamwise direction interacting with streaks of high- and low-velocity fluid. During times when low-velocity fluid is pushed upward by rotation of the streamwise vortices, turbulence energy production intensifies.

In both high-pressure and low-pressure turbine blade passages, using any working fluid in liquid and/or gas phase, there may be a need to cool the blade material on both the suction and the pressure side of the passage. This can be achieved by passing a cooling fluid along turbine blades to cool the boundary layer fluid on the blade surfaces by convection. For efficient cooling, it is desirable to have high convection heat transfer rates which are possible when the flow is locally turbulent. This is a challenging issue because on the pressure side of the blade passage, flow relaminarizes and the convection heat transfer rates are low.

### SUMMARY

A phononic material includes an interface surface and a subsurface feature mechanically connected to the interface surface. When a hypersonic flow having at least one instability flows past the interface surface, the interface surface vibrates in response to one or more frequency components of the pressure. The interface surface couples each frequency component into the subsurface feature, which at least partially reflects and phase-shifts each frequency component to generate a corresponding phase-shifted frequency component. The interface surface vibrates in response to the phase-shifted frequency component, thereby coupling the phase-shifted frequency component back into the hypersonic flow. The phase-shifted frequency component interferes with said each frequency component within the hypersonic flow. The subsurface feature may perform phase-shifting such that the phase-shifted frequency component destructively interferes with said each frequency component, thereby reducing the at least one instability.

A method for controlling a hypersonic flow that has at least one instability includes coupling, with the interface surface of any of the phononic materials of the present embodiments, one or more frequency components of a pressure of the hypersonic flow into the subsurface feature of the phononic material. The method also includes reflecting and phase-shifting, with the subsurface feature, each of the one or more frequency components to generate a phase-shifted frequency component. The method also includes coupling, with the interface surface, the phase-shifted frequency component into the hypersonic flow. The method also includes interfering the phase-shifted frequency component with said each of the one or more frequency components within the hypersonic flow.

### BRIEF DESCRIPTION OF THE FIGURES

FIG. 1 is a diagram illustrating a phononic material interacting with a hypersonic flow, according to an embodiment.

FIG. 2 is a diagram illustrating a direct numerical simulation of a phononic material reducing turbulence of a hypersonic flow, according to an embodiment.

FIG. 3 depicts three graphs mapping the direct numerical simulation of the phononic material interacting with the hypersonic flow from FIG. 2, and a performance metric, according to embodiments.

FIGS. 4A and B are diagrams illustrating phononic materials with and without an interface, respectively, interacting with a hypersonic flow, according to embodiments.

FIG. 5A depicts example dispersion curves for a one-dimensional phononic material from which the subsurface is composed (Brillouin zone illustrated in inset) as shown in FIG. 4B, according to an embodiment.

FIG. 5B depicts an example steady-state vibration response of the phononic material surface representing the interface with the flow as shown in FIG. 4B, according to an embodiment.

FIG. 5C depicts an example time-averaged phase between force and displacement at the phononic material surface representing the interface with the flow as shown in FIG. 4B, according to an embodiment.

FIG. 5D depicts an example performance metric combining amplitude and relative phase between the force and the displacement at the phononic material surface representing the interface with the flow as shown in FIG. 4B, according to an embodiment.

FIG. 6 depicts a plurality of example configurations of phononic materials that may be used to form a phononic subsurface, according to embodiments;

FIGS. 7A-7E are schematic drawings showing example configurations of the phononic material, according to embodiments.

FIGS. 8A-8H are schematic drawings showing example configurations of the phononic material, according to embodiments.

FIGS. 9A-9F are schematic drawings showing example configurations of the phononic material, according to embodiments.

FIG. 10 depicts other example configurations of the phononic metamaterial, according to embodiments.

FIG. 11 depicts yet other example configurations of the phononic metamaterial, according to embodiments.

FIG. 12 depicts other example configurations of the phononic metamaterial, according to embodiments.

FIG. 13 depicts yet other example configurations of the phononic metamaterial, according to embodiments.

FIG. 14 depicts yet other example configurations of the phononic metamaterial, according to embodiments.

FIGS. 15A-15C depict yet other example configurations of phononic materials comprising lattice structures, according to embodiments.

FIGS. 16A-16C show further example 3D lattice structured phononic materials, according to embodiments.

FIG. 17 depicts further example 3D lattice structured phononic materials, according to embodiments.

### DETAILED DESCRIPTION

Laminar-to-turbulent transition in hypersonic boundary layer flows (flows at speeds equal to or higher than five times the speed of sound) bring rise to substantial and undesirable increases in wall temperature and skin-friction drag, which result in adverse problems for vehicle structural design, materials selection, and performance, and in limitations on maximum attainable speed, operation conditions, reliability and lifespan, and fuel efficiency. A large surface temperature rise severely constrains the type of material that may be used for the surface.

Unlike the laminar-to-turbulent transition process for subsonic flows, there is relatively limited research on the mechanisms of transition and their control in the hypersonic regime, in both experiment and theory. However there has been some recent critical advancements on elucidating the relationship between the modal dynamics of flow instabilities and surface temperature. At high Mach numbers (M>5), two unstable modes have been identified in recent research in the field: an inviscid, supersonic instability (Mach mode) (i.e., first-mode instability) and an acoustic second-mode instability. The second mode is the dominant instability that governs the occurrence and development of laminar-to-turbulent transition, and recent research has revealed that the rise of this mode correlates directly with a rise in the surface temperature. It is generally understood that the transition process begins only when the second mode, which in some cases have been found to be centered around a frequency of f=230-280 kHz but could vary depending on application and conditions, is highly or fully developed.

Consequently, intervention with the second mode instability is of interest for hypersonic air travel as it may be a key to suppressing the transition process to turbulence in an effective and efficient manner. Extending to a more practical geometry such as boundary layer transition (BOLT), multiple transition modes including cross-stream instabilities, in addition to Mack modes, are also active. A technique to suppress the second mode (and simultaneously other relevant modes including but not limited to the first mode whenever possible) present in hypersonic flows will lead to significantly decreasing the level of the temperature rises on the surface or potentially eliminating these temperature rises altogether. Furthermore, surface friction drag would be reduced as a result of this control process. At present, very few methods have been demonstrated to accomplish the key goal of second-mode stabilization; furthermore, existing methods lack a foundational theory and do not exhibit the tunability to strengthen and sharpen the effectiveness for various practical situations as well as scalability to practical configurations. These issues motivate the present disclosure, which circumvents the deficiencies of the past approaches and provides a novel and scalable design method (and corresponding material/structural system) to stabilize a laminar hypersonic flow, and consequently avoid or minimize the undesired temperature spikes it manifests at the fluid-material surface as well as reduce surface-friction drag.

In the present disclosure, the notion of a phononic subsurface (PSub) is used to achieve passive (or active) hypersonic flow control. A PSub is an architectured material or structure placed underneath a surface exposed to the flow—and interfacing with the flow—designed to passively attenuate instability waves via destructive interferences. Inherent to this mechanism is a process whereby energy transfer from the mean flow to the unstable disturbances is reversed by the presence of the PSub. It is therefore not a traditional approach based on damping or dissipation. Instead, it is based primarily on wave interferences (e.g., wave cancellations).

In the case of hypersonic flow control, this entails that the PSub be designed to primarily cause destructive interferences (e.g., via wave cancellation) of the second instability mode, which is known in the literature to be associated with temperature rises on the surface. With the provided design method, and specified range of material/structural configurations, the second instability mode will be subject to ongoing, steady-state or transient mechanisms of wave stabilization during operation and, consequently, this will lead to the prevention or reduction of severe temperature rises on the surface and will also enable surface-friction drag reduction. The PSub may also be designed to simultaneously suppress other types of unstable modes in the hypersonic flow leading to a more comprehensive and effective stabilization of flow instabilities and consequently delay the laminar-to-turbulent transition state and delay or prevent all associated phenomena. The PSub may also reduce instabilities, drag, and temperature rises associated with turbulence if the hypersonic flow ultimately reaches a fully turbulent state. Key advantages of preventing the high temperature levels at the surface include reduction of the high temperature-resistance constraint in material selection, increase in lifespan and reliability, and increase in the maximum allowable speed of operation of a hypersonic vehicle utilizing this technology.

In embodiments, a practical configuration for a PSub designed for this purpose is based on a lattice-structure comprising a thin high-temperature resistant material at the surface exposed to the flow. Example high temperature-resistant materials include titanium as well as C—SiC and SiC—SiC composites or other metal/ceramic composite materials or other similar materials. Other high-temperature materials or combinations of materials for the entire PSub or the portion that interfaces with the flow (interface surface as used herein). As an example, high-temperature resistant morphing thin sheets could be utilized at the flow interfacing surface or the entire PSub (which itself, as an example, could be lattice-based, i.e., PSubL, see below for more details); these could be made out of C—SiC and SiC—SiC composites, composite sheets, or other similar materials.

In some examples, the problem of passive control of hypersonic flow in a boundary layer interfacing with a surface at an elevated temperature environment and subject to further increases in temperature due to the fluid-structure interaction at hypersonic flow conditions are addressed. For the purpose of demonstration, examples provided herein focus on the control of second-mode instability waves in simple geometries such as hypersonic channel flows and hypersonic boundary layer flows over a flat surface. Other instabilities within a hypersonic flow, such as but not limited to the first mode and other modes of instability, may also be targeted in the same manner. Also, other more complex surface shapes/configuration such as that of a wing, fuselage, or a rocket, or other advanced vehicle shapes, may also be targeted in the same manner.

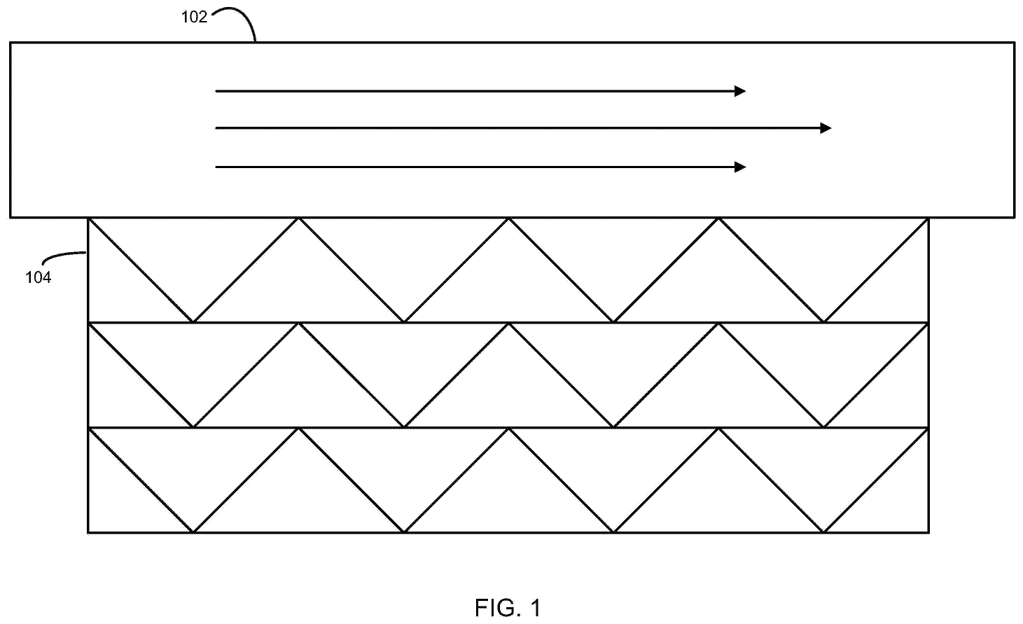

In embodiments, for the PSub, a metal-polymer layered composite used for subsonic flow may be replaced with a high temperature structure, such as but not limited to an all-titanium sublattice structure, hence generating a phononic subsurface-subslattice (PSubL 104), as shown in FIG. 1. In embodiments, the PSubL 104 comprises a titanium cage with a triangular lattice core in which the core is made out of a network of titanium beams. Such structure is both light weight and high-temperature resistant, which makes it suitable for potential use in a hypersonic aircraft. Alternatively, example lattice geometries may include hexagonal honeycomb, triangular honeycomb Kagome lattice, square honeycomb, among others (see Journal of the Acoustical Society of America, 119(4), April 2006 by Phani et al.)

In embodiments, a schematic demonstrating placement of a possible realization of proposed phononic subsurface-sublattice PSubL 104, positioned relative to a hypersonic flow 102. As discussed above, contact between the PSubL 104 and the hypersonic flow 102 may result in a laminar flow transitioning to a turbulent flow, with a first-mode and second-mode instabilities (not shown). The main driving force of the transition to a turbulent flow is the second-mode instabilities. Such second-mode instabilities may be countered by the PSubL 104, as discussed above.

Coupled fluid-structure direct numerical simulations (DNS) of subsonic flow has indicated that utilization of a periodic material placed underneath the surface (forming a PSub) has the capacity to counter flow instabilities through a precise mechanistic and repeatable approach involving concepts from phonon wave propagation in crystals. Unlike compliant surfaces, a phononic material is relatively stiff and exhibits a frequency band structure and as such the technique does not depend on damping/dissipation as the key mechanism. To date, the problem that has been investigated—yielding successful results—is that of subsonic laminar channel flow with two-dimensional (2D) linear disturbances.

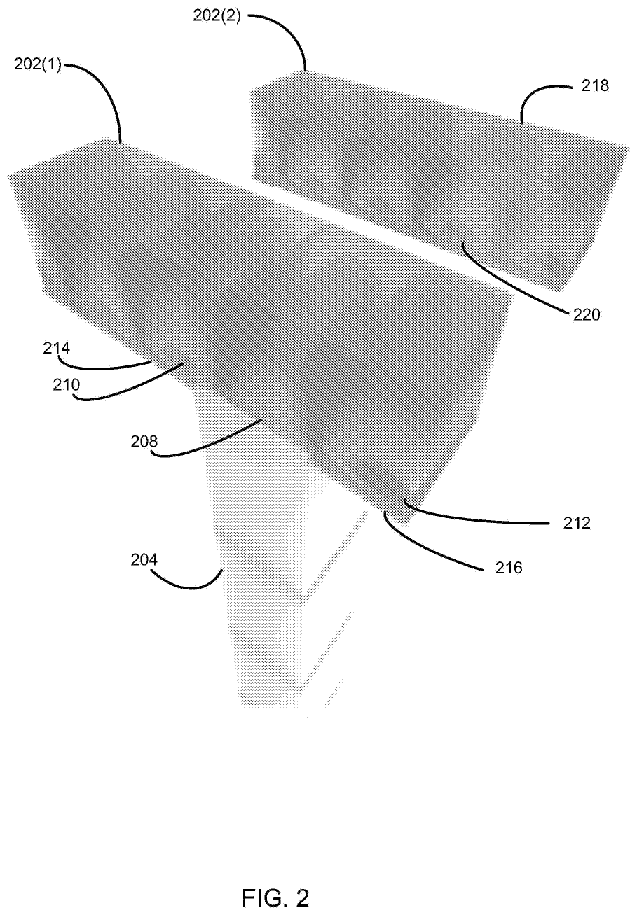

FIG. 2 illustrates the PSub concept using an actual result from the inventor's prior work with his collaborators. The underlying mechanism that has been utilized is the coupling of a PSub's stop-band phasing and wave interference behavior with that of the flow instabilities in order to induce stabilization (via wave cancellation), or destabilization (via wave addition), as desired. The key design criterion to enable this effect is based on a selection of the material and geometric properties of the PSub in a manner that tunes the vibration amplitude and phase response of the PSub boundary interfacing with the flow such that the amplitude is maximized and the phase is negative.

FIG. 2 depicts the DNS from the hypersonic flow 202(1) (e.g., hypersonic flow 102) interacting with the phononic material 204 (e.g., PSubL 104). The hypersonic flow 202(2) is used as a control group to contrast the reduction in turbulence caused by the phononic material 204 making contact with the hypersonic flow. For example, section 208 of the hypersonic flow 202(1) in contact with the phononic material 204 shows a reduced turbulence contrasted with the adjacent sections 210, 212, as indicated by the dark gray areas 214, 216 representing various degrees of turbulence, not present in section 208. Further, section 208, in contrast with section 218, of hypersonic flow 202(2) illustrates the effect from the phononic material 204 contacting the hypersonic flow 202(1), as indicated by the dark-gray shading indicating turbulence 220.

Graph 302(1) illustrates the normalized amplitude response of the PSubL (e.g., phononic materials 104, 204, 404, 604(1)-(3), 504) to the hypersonic flow (e.g., hypersonic flows 102, 202, 406) as a function of the frequency of the hypersonic flow pressure exerted therefrom. Graph 302(2) illustrates a normalized phase response of the PSubL to the hypersonic flow as a function of the frequency of the hypersonic flow pressure exerted therefrom. Each of graphs 302(1)-(3) are computed based on a stand-alone model of the PSubL comprising a repetition of unit cells composed of beams and following a triangular lattice symmetry (e.g., the phononic material 104, FIG. 1). Graph 302(3) illustrates a performance metric for predicted response of the PSubL for unstable hypersonic modes. A negative value of the performance metric implies stabilization; the magnitude of the metric (in the negative axis) represents the expected intensity of the stabilization.

Reduction in flow instabilities (e.g., present in a laminar or turbulent flow before a transition to a fully turbulent flow) can be measured in the reduction of kinetic energy in the flow and/or reduction of surface drag along the flow surface at the interface of the flow surface and the subsurface material. The flow in this context comprises the motion of a fluid medium of gas or liquid, or a gas-liquid mixture, or a gas-liquid-solid mixture, or a liquid-solid mixture, or a gas-solid mixture. The concept comprising interaction with the velocity and/or pressure fields of a flow can be used to control laminar, pre-turbulent, or turbulent flows in order to reduce local skin friction and hence to reduce drag on surfaces and bodies that move in a fluid medium of gas or liquid, a gas-liquid mixture, a gas-liquid-solid mixture, a liquid-solid mixture or a gas-solid mixture.

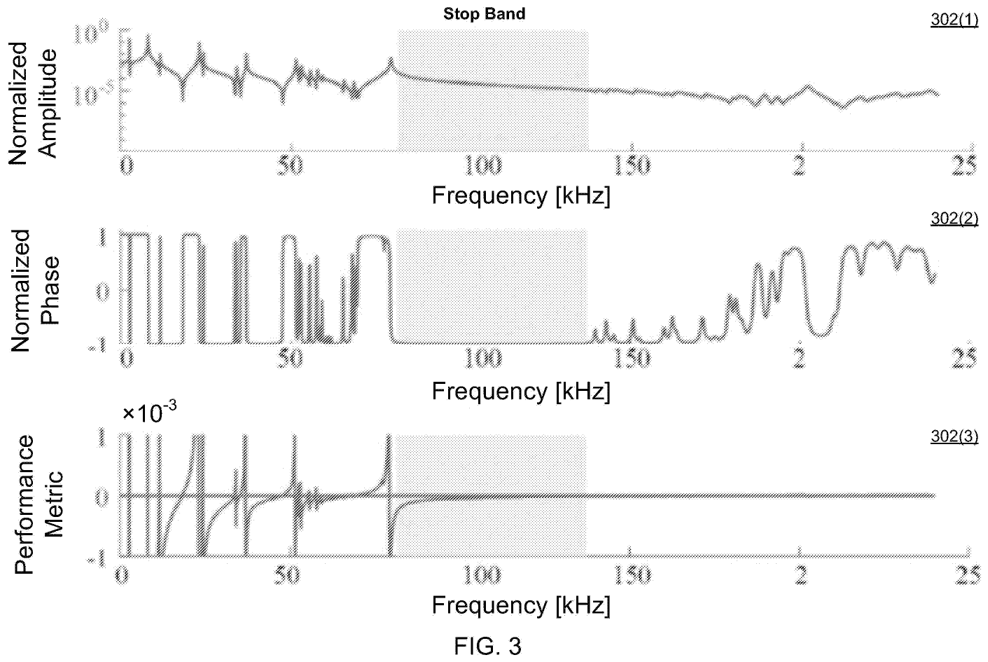

One example methodology for designing a phononic subsurface material for reducing instabilities in a laminar, pre-turbulent, or turbulent hypersonic flow is as follows. First, a unit cell of the phononic subsurface material is designed and/or optimized to interact with a hypersonic flow. Then, a steady-state frequency response analysis is conducted on a model representing a finite structure composed of one or more unit cells of the type designed above. The unit cells may be laid out in the direction perpendicular, or parallel, or both, to the surface (and flow). The unit cell and possibly the end design and boundary conditions of the structure are then altered until the interaction with the flow operates as desired. A performance metric (e.g., as discussed with reference to FIG. 3) is then used to evaluate the predicted performance of the phononic subsurface material as explained in more detail below. In this implementation, the performance metric (e.g., graph 302(3)) is a product of the amplitude (e.g., graph 302(1)) and phase (e.g., graph 302(2)) of the response at the edge of a lattice subsurface (e.g., PSubL 104, 204, 404) exposed to a hypersonic flow (e.g., hypersonic flow 106, 202, 406). The process may be repeated in some implementations, such as until the predicted performance metric gives a negative value with the highest (or at least acceptable, predetermined or designed) possible absolute value of amplitude and/or meeting one or more design criteria for flow stabilization; or gives a positive value with the highest (or at least acceptable, predetermined or designed) possible absolute value of amplitude and/or meeting one or more design criteria for flow destabilization. The metric is evaluated at the frequency or frequency range of the flow instability that is to be controlled. The process can also be repeated to cover multiple frequencies or a contiguous range of frequencies covering the frequencies of the instabilities that the phononic subsurface is designed to control.

In another example methodology, a lattice subsurface structure may be designed offline (such as using a compliance criteria as described in U.S. provisional application No. 62/891,325 entitled “STRUCTURAL SUB SURFACE MATERIAL FOR TURBULENT FLOW CONTROL” filed on Aug. 24, 2019 (attorney docket no. CU5126B-PPA1), which is hereby incorporated by reference in its entirety), and may or may not be designed by iterations. One advantage of this approach is that the PSubL (phononic subsurface material) can be fully designed without carrying out any coupled fluid-structure simulations (which tend to be computationally expensive). However, a fluid-structure simulation may be conducted as a verification and finetuning, especially to ensure that the level of damping (material and structural) in the phononic subsurface material is optimal and/or meets one or more design criteria. The effective structural compliance of this lattice structure, as measured along the vertical direction in each of the figures, is a key metric in determining the reduction in intensity of turbulence in the flow; higher effective structure compliance leads to lower turbulence intensity, which leads to lower skin-friction drag. The distributed load of the hypersonic flow is applied at the design stage to allow us to calculate the effective structural compliance of the PSub. The higher the effective structural compliance of the PSub the more effective it is in reducing the intensity of turbulence and hence in reducing skin-friction drag.

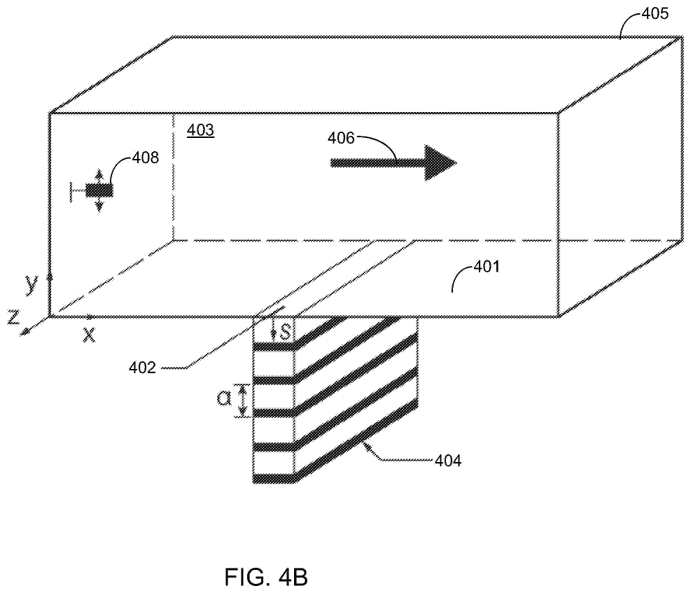

In one example embodiment, a performance metric (e.g., the performance metric of FIG. 5D) may be determined based on a stiffness or compliance of a structural subsurface material where the flow surface is in the range of relatively high stiffness, i.e., the flow surface does not exhibit relatively large finite deformation (as opposed to infinitesimal deformation or minor finite deformation) and effectively remains substantially straight and retains its shape in response to a passing flow of interest. In one particular implementation, for example, the deformation can be small such that the shape of the surface profile practically does not change in response to a flow, yet is compliant enough to permit the structural subsurface material to move in response to the flow. As discussed herein, the stiffness or compliance are inverse of each other, i.e., compliance=1/stiffness. As the structural compliance of the material increases (and the corresponding stiffness decreases), the performance of the structural subsurface material increases for a partially developed or fully developed turbulent flow.

The lower the effective stiffness (primarily in the direction perpendicular to the flow surface but also with variants/components in different directions as observed at the interface of the flow surface and the flow) of the structural subsurface material where the flow surface remains effectively substantially straight in response to a flow of interest, the better the performance of the structural subsurface material in reducing surface friction drag from turbulence of the flow. For the same structural subsurface material compared to a solid homogeneous structure of the same material, the deeper/longer (dimension extending at least substantially perpendicular to the flow) the dimension of the structural subsurface material, the lower the effective stiffness of the structural subsurface material, such as in a dimension perpendicular to the flow, and the better the performance of the structural subsurface material at reducing surface friction drag from the turbulence of the flow.

Design and construction of materials or structures that work on the fundamental concepts from phonon physics utilizing Bragg scattering and internal resonances (separately or in combination) are provided. In various implementations, the materials or structures (e.g., structures that take the form of a lattice in some example implementations provided herein) can be implemented to open band gaps in their frequency responses to form stop bands to induce “out-of phasing” and, conversely, pass-bands to induce “in-phasing” in the interacting fluid flow (gases and liquids, single phase and multi-phase), as well as in flowing solids like ice and snow, they are in contact with, for the purpose of flow control. The stop-bands and pass-bands can also be designed to enhance and/or absorb energy in the fluids, advance or delay flow separation, enhance or reduce lift, reduce or enhance surface flutter and alter heat transfer within the flow by changing flow characteristics.

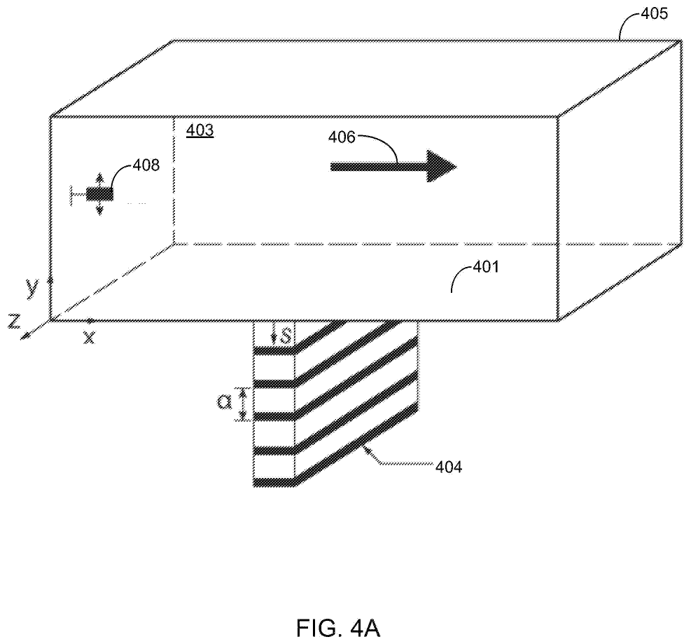

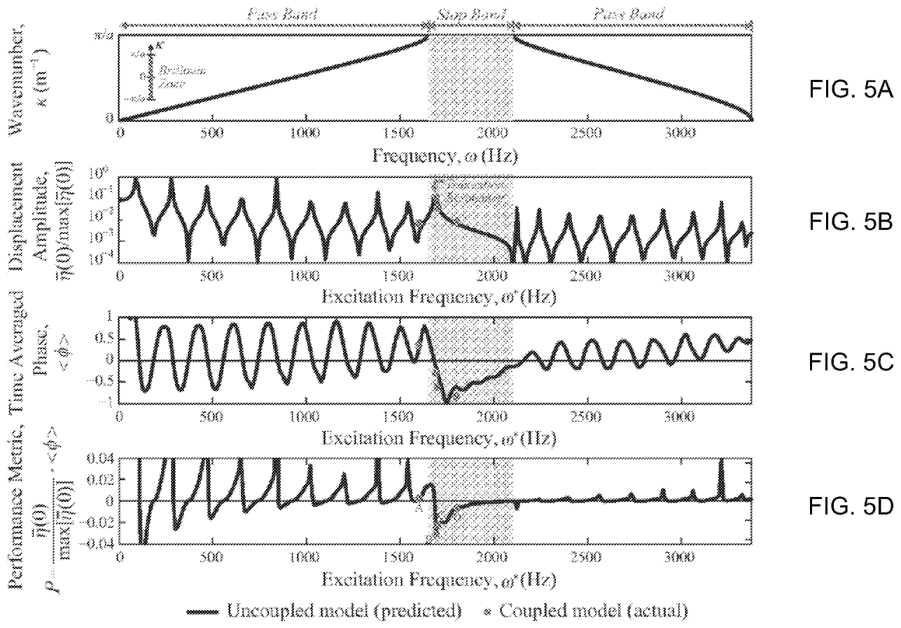

Phononic subsurface(s) include phononic crystals designed based on the Bragg scattering principle, locally resonant metamaterials (also referred to as locally resonant elastic metamaterials or locally resonant acoustic metamaterials) that work on the principle of internal resonances and mode hybridization, and/or periodic structures. As depicted in FIG. 4, the concept comprises the introduction of an elastic medium (phononic crystal, locally resonant metamaterial, or periodic structure), such as a phononic material 404, located at one or more points or regions of interest along a surface (e.g., surface 401), and extending in a manner such that its spatial periodicity is along a depth (e.g., along S, FIGS. 4A and 4B), e.g., perpendicular to the surface, at an angle to the surface, along the surface or any combination thereof. One example implementation is shown in FIG. 4, in which a segment of a surface 401 (e.g., a bottom surface) of a flow channel 403 with otherwise all-rigid walls 405 is replaced with a one-dimensional (1D) elastic phononic subsurface 404 extending away from the flow surface of the flow channel. The phononic subsurface shown in FIG. 4 may comprise a phononic material, such as a phononic crystal, locally resonant metamaterials, or periodic structures. The phononic material may comprise a material, as discussed above, including titanium, and may be designed according to any shape, include triangular sublattice, or the phononic materials 604(1)-(3) depicted in FIG. 6.

Stabilization can be accomplished within a stop band (at frequencies falling to the right of a truncation resonance) by inducing destructive interferences in the velocity and/or pressure fields of a hypersonic flow 406 that lead to attenuation of instability wave amplitudes in the flow, including first and second mode instabilities. Conversely, hypersonic flow destabilization is induced within a pass band (in certain frequency windows) by inducing constructive interferences in the velocity and/or pressure fields of the hypersonic flow that amplify disturbance wave amplitudes in the hypersonic flow. The hypersonic flow in this context comprises the motion of a fluid medium of gas or liquid, or a gas-liquid mixture, or a gas-liquid-solid mixture, or a liquid-solid mixture, or a gas-solid mixture. The same concept comprising destructive and/or constructive interference of the velocity and/or pressure fields of the hypersonic flow can also be used to control turbulent hypersonic flows (e.g., driven by second-mode instabilities) in order to reduce or enhance local skin friction and hence to reduce or enhance drag on surfaces and bodies that move in a fluid medium of gas or liquid, a gas-liquid mixture, a gas-liquid-solid mixture, a liquid-solid mixture or a gas-solid mixture. The same concept comprising destructive and/or constructive interference in the velocity and/or pressure fields of the hypersonic flow is also utilized for enhancing/controlling the degree of mixing in laminar/turbulent liquid-gas mixtures, mixtures of different liquids, mixtures of different gases, mixtures of liquid-gas-solid, mixtures of liquid-solid, mixtures of gas-solid and combustibles, enhancing or attenuating heat transfer rates within the hypersonic flow, advancing or delaying separation, enhancing or reducing lift, and/or reduce or enhance surface flutter.

One example methodology for designing a phononic subsurface for stabilizing an unstable wave at a particular frequency is as follows. First, the unit cell of the phononic subsurface is designed and optimized to exhibit a stop band (band-gap) encompassing the frequency of the instability wave. Then, a steady-state frequency response analysis is conducted on a model representing a finite structure composed of one or more unit cells of the type designed above. The unit cells may be laid out in the direction perpendicular, or parallel, or both, to the surface (and flow). The unit cell and possibly the end design and boundary conditions of the structure are then altered until the periodicity truncation resonance that is closest to the instability wave frequency is located as close as possible and to the left of the instability wave frequency. A performance metric is then used to evaluate the predicted performance of the phononic subsurface as explained in more detail below. The process is repeated (or finetuned) until the predicted performance metric gives a negative value with the highest possible absolute value.

One advantage of this approach is that the phononic subsurface can be fully designed without carrying out any coupled fluid-structure simulations (which tend to be computationally expensive). However, a fluid-structure simulation may be conducted as a verification, especially to ensure that the level of damping (material and structural) in the phononic subsurface is optimal.

The same process as the one mentioned above may be adopted for destabilization, with the exception that (1) the unit cell in this case is designed to exhibit a pass band around the frequency of interest and (2) the structure overall (including the unit cell layout) is designed such that the frequency of interest matches a pass-band resonance frequency.

In one implementation, for example, an effective structural compliance of a subsurface structure can be defined as a quantity that describes total deformation of the subsurface structure in a direction perpendicular to the flow divided by the total applied resultant force acting from the flow onto the subsurface structure through the fluid-structure interface. For example, if the structural subsurface has n layers laid out perpendicular to the flow, then the total deformation of the subsurface in the direction of the flow will be

$$Δ {l}_{tot} = Δ {l}_{1} + Δ {l}_{2} + … + Δ {l}_{i} + … + Δ {l}_{n} = \frac{F {l}_{1}}{{E}_{1} {A}_{1}} + \frac{F {l}_{2}}{{E}_{2} {A}_{2}} + … + \frac{F {l}_{t}}{{E}_{i} {A}_{i}} + … + \frac{F {l}_{n}}{{E}_{n} {A}_{n}} ,$$

where Δlᵢ is the deformation of layer i, F is the total resultant applied force from the flow onto the structure in the direction perpendicular to the flow, lᵢ is the length of the layer in the direction perpendicular to the flow, Eᵢ is the Young's modulus of the material of the layer, and Aᵢ is the cross-sectional area of the layer in the direction perpendicular to the flow. It follows that the effective structural compliance of the subsurface for this case is

$${C}_{Eff} = \frac{Δ {l}_{tot}}{F} = \frac{1}{A} ( \frac{{l}_{i}}{{E}_{1}} + \frac{{l}_{2}}{{E}_{2}} + … + \frac{{l}_{n}}{{E}_{n}} ) .$$

In another example methodology, a subsurface structure may be designed offline using a compliance criterion as described herein, and not need to be designed by iterations. One advantage of this approach is that the structural subsurface material can be fully designed without carrying out any coupled fluid-structure simulations (which tend to be computationally expensive). However, a fluid-structure simulation may be conducted as a verification, especially to ensure that the level of damping (material and structural) in the structural subsurface material is optimal and/or meets one or more design criteria.

In various embodiments, one or more subsurface structure elements may be used to control the overall structural compliance of a subsurface structure by selection of its material(s) and/or structural geometry and dimensions. In one embodiment, for example, a structural material may be distributed, such as but not limited to in a direction perpendicular to a solid flow surface, such that the overall structural compliance (opposite of stiffness) of the that structure results in a decrease in drag along the flow surface adjacent or juxtaposed to where the subsurface structure is applied. This effectively reduces negative effects of turbulence. Prior approaches place a thin “surface material” or a thin “coating” along the surface; these do not extend in a direction away from the flow surface (e.g., in the perpendicular direction from the flow surface) and therefore need to be overly compliant (i.e., like rubber) to reduce the drag. In embodiments provided herein, a subsurface material may comprise a relatively stiff material (like plastic) because the overall structural compliance need not be defined just by the type of material but by the fact that the subsurface material extends as a structure away from the flow surface. The longer the extension, the lower the stiffness (the higher the compliance) as felt by the flow. As described herein, the structural subsurface may comprise a number of different size, shape and location structural subsurface materials that may be adapted for different turbulent flow conditions.

While the above descriptions are concerned with the manipulation of a single frequency (unstable wave for stabilization or vice versa), the methodology can be extended to cover particular frequencies and their harmonics (which is relevant to nonlinear instabilities and transition problems) and a range of frequencies (which is relevant to turbulence problems).

### Flow and Solid Surface Control

In some implementations, for example, phononic subsurfaces (e.g., the phononic subsurfaces 104, 304, 404, 504) in general can be used in applications, such as, but not limited to any air, sea and land vehicles, manned and unmanned (drones), water and wind turbine blades, propellers, fans, steam and gas turbines blades, among other applications, for the purposes of drag reduction, drag enhancement, turbulence reduction, turbulence enhancement (e.g., in fluid mixing), linear instability suppression, nonlinear instability suppression, transition delay/promotion, enhanced maneuverability, lift enhancement; heat transfer control (enhancement and/or reduction), noise control, vibration control, flutter avoidance, inducing surface movement in all three coordinate directions; separation delay, among others.

### Fluids

Examples of fluids that may be used with phononic subsurfaces (PSubL) (e.g., the phononic subsurfaces 104, 204, 404, 604) such as described herein, include, but are not limited to, the following: all fluids, gases, liquids, single and multiphase, mixtures, and the like. In one particular implementation, for example, air, water, oil, natural gas, sewage or other fluids may be used with phononic subsurfaces. Fluids can exist at room temperature, lower than room temperature, higher than room temperature. Applications cover static fluids, incompressible fluids, subsonic, transonic, supersonic, hypersonic flow regimes; laminar, turbulent and transitional flow regimes, comprising at least a first and second-mode instabilities; smooth surfaces, surfaces with surface roughness—appearing naturally and by transition; instability, transition and turbulence—instigated naturally, with acoustic excitations, with finite-size roughness elements of any shape, plant canopies, others; by-pass instabilities, transition and turbulence.

Flow control applications cover all flow fields. These include (but are not limited to) external and internal flows, and their various combination; all flow fields are included.

### External Flows

Flows over aircraft wings (passenger aircraft, fighter aircraft, tankers, military aircraft, all fixed wing aircraft, manned and unmanned aircraft, rotary wing aircraft, helicopters, vertical take-off aircraft, space vehicles, re-usable space vehicles, aircraft with jet engines, aircraft with propellers, ship-based Navy aircraft); flow control in wing-body junctions, over fuselages, in and around aircraft engine inlets, turbines, over turbine blades, blade passages, wind turbine blades; wings of any cross-section, symmetric, non-symmetric, with and without camber, all wing, airfoil and hydrofoil profiles (including NACA and NASA airfoils), delta wings, folding wings, retractable wings, wing appendages, high-lift devices. Flows around sea vehicles including ships (battleships, cruise ships, cargo ships-manned), tankers, carriers, racing boats, sailing boats, unmanned boats submarines (manned and unmanned), deep-sea vehicles, hovercrafts, jet skis, water boards, among others. Flows around wind turbine blades of any type and water and steam turbines of any type.

Internal flows (of any fluid, gas and/or liquid): flows in pipes, open or closed (channels), of any cross-sectional shape, and length, and at any temperature, and of sudden or gradual expansion; pipes of circular, square, elliptic, rectangular, triangular shapes, of any material; pipes with surface heating and/or cooling, pump-driven, gravity driven, buoyancy-driven. Pump impellers, steam turbines, pump and turbine inlet and outlet passages, flows over their blades.

The applications further cover ships, ship hulls, ship propellers, passenger ships, cruise ships, military ships of all kinds, sizes and uses, ordinance deployed in air and sea faring military manned and/or unmanned vehicles, speed boats, race boats, sail boats of all kind, used for pleasure, transportation, cargo, racing. Snow vehicles, alpine and cross-country skis, snow boards, paddle boats, wind surfing boards, parachute (ski) surfing boards, swim suits, skates, skate boards, water skiing boards.

Any solid surface that is made of any material may be used in the application of the key concept, including (but are limited to) aluminum, plastic/polymer (all types), titanium, steel, copper, cement, rare earth, high-temperature resistant ceramics; all materials (natural or synthetic) that are in contact with any fluid are included in the scope of applications mentioned in this disclosure.

### Phononic Subsurface

Phononic subsurface material(s) provided herein may comprise materials comprising materials such as, but not limited to, such as titanium, metal, rubber, polymer, ceramic, wood, C—SiC and SiC—SiC composites or other metal/ceramic composite materials or other similar materials, some combination thereof, and/or the like. The concept comprises the introduction of an elastic medium (in this case, the lattice phononic subsurface material, such as PSubL 104, 204, 404, 604, located at one or more points or regions of interest along and/or forming a solid flow surface (such as surface 401), and extending away from the solid flow surface, e.g., perpendicular to the surface, at an angle to the surface, along the surface or any combination thereof. One example implementation is shown in FIG. 4, in which a segment of a surface (e.g., a bottom surface 401) of a flow channel 406 with otherwise all-rigid walls is replaced with a one-dimensional (1D) elastic lattice phononic subsurface material 404 extending away from the flow surface 101.

The phononic subsurface material 404 shown in FIGS. 4A and 4B may be any phononic subsurface material, including phononic crystals, elastic metamaterials, and periodic structures. In embodiments, phononic subsurface 104 may comprise materials, such as but not limited to phononic crystals designed based on the Bragg scattering principle and/or locally resonant metamaterials (also referred to as locally resonant elastic metamaterials or locally resonant acoustic metamaterials) that work on the principle of internal resonances and mode hybridization. The concept comprises the introduction of an elastic medium (phononic crystal or locally resonant metamaterial), located at one or more points or regions of interest along surface 101, and extending in a manner such that its spatial periodicity (i.e., a) is along a depth, e.g., perpendicular to the surface, at a non-perpendicular angle to the surface, along the surface or any combination thereof.

In embodiments, phononic subsurface(s) may comprise other, materials, such as but not limited to metal, rubber, polymer, ceramic, wood, or the like. In certain implementations where a flow may create a significant amount of heat, such as in a hypersonic flow, heat resistant materials such as metals (e.g., titanium) or ceramics may be particularly advantageous.

As described above, the concept comprises the introduction of an elastic medium (the phononic subsurface material), located at one or more points or regions of interest along a flow surface 401, and extending away from the flow surface, e.g., perpendicular to the surface, at an angle to the surface, along the surface or any combination thereof. One example implementation is shown in FIG. 4, in which a segment of a surface 401 (e.g., a bottom surface) of a flow channel 403 with otherwise all-rigid walls is replaced with a one-dimensional (1D) elastic lattice-based phononic subsurface material extending away from the flow surface 401.

FIG. 4B shows an exemplary embodiment of the phononic material 404 that includes an internal surface 402 comprising a high-temperature-resistant material adapted to move in response to a pressure associated with at least one wave of the hypersonic flow 406 exerted on the interface surface 402. A subsurface feature extends from the interface surface 402 and comprises the phononic material 404 (e.g., such as a phononic crystal, locally resonant metamaterial, and/or periodic structure) adapted to receive the at least one wave having the at least one frequency based upon the pressure from the flow via the interface surface 402 and alter a phase of the at least one wave. The interface surface 402 is adapted to vibrate at a frequency, phase, and amplitude in response to the altered phase of the at least one wave and the subsurface feature comprises at least one of titanium and a high-temperature resistant material or a high-temperature resistant composite material. The interface surface 402 may be in direct contact with the hypersonic flow 406.

FIG. 5A depicts example dispersion curves for a one-dimensional layered phononic material (the phononic subsurfaces 104, 204, 404, 604) from which the subsurface is composed (Brillouin zone illustrated in inset) as shown in FIGS. 4A and 4B. FIG. 5B depicts an example steady-state vibration response of the phononic material surface representing the interface with the flow as shown in FIGS. 4A and 4B. FIG. 5C depicts an example time-averaged phase between force and displacement at the phononic material surface representing the interface with the flow as shown in FIGS. 4A and 4B. FIG. 5D depicts an example performance metric combining amplitude and relative phase between the force and the displacement at the phononic material surface representing the interface with the flow as shown in FIGS. 4A and 4B. In FIGS. 5B-5D, results obtained by analyzing the phononic materials (e.g., phononic crystals, elastic metamaterials, and periodic structures) alone (without coupling to the flow) are represented by black solid curves. Results from the coupled fluid-structure simulations are represented by dots. In FIG. 5B, the four coupled simulation data points are all multiplied by a single common constant to calibrate with the uncoupled model curve.

In embodiments, a lattice phononic subsurface material comprises a lattice structure comprising a plurality of structural elements (e.g., beams, rods, etc.) and voids/holes. The lattice structure disposed adjacent the flow exhibits band gaps for interacting with the flow. A phononic subsurface could be made of a phononic crystal (periodic composite material), a locally resonant metamaterial (material with embedded or attached local resonators which can be laid our periodically or non-periodically), and/or periodic structure. In both cases, a material variation or variation of geometric feature could extend in a one-, two- or three-dimensional sense, and could comprise one, two, or more constituent materials. FIG. 6 demonstrates different example configurations of phononic materials 604(1)-(3) (e.g., phononic crystals, elastic metamaterials, and periodic structures) used in a phononic subsurface implementation. The various examples include one-dimensional (1D) 604(1), two-dimensional (2) 604(2), and three-dimensional (3D) 604(3) example configurations.

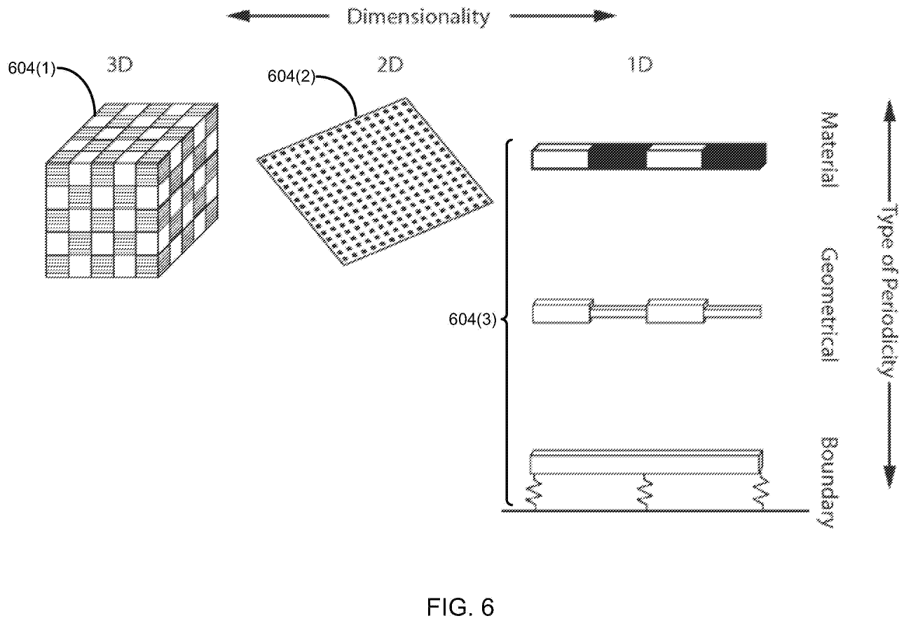

The applications and patents incorporated herein describe a wide range of phononic subsurface structures and configurations that may be used as the phononic subsurface structures described herein. FIGS. 7-18 in PCT application no. PCT/US20/47703 show a number of example phononic subsurface structures. Additional example structures are further found throughout the applications incorporated by reference.

FIGS. 7-18 demonstrate different possible configurations of locally resonant metamaterials comprising the phononic subsurface. FIG. 7, for example, shows schematic diagrams of example configurations of phononic crystals and metamaterials that may be used to form a phononic subsurface. In the example labeled as A, for example, different perspective views of one implementation of a plate including a generally two-dimensional (2D) uniform, periodic array of equal-sized pillars disposed on a single surface (e.g., a top surface) of the plate is shown. Although the pillars are shown example A of FIG. 7 to have a square cross-section, they can have any other cross-sectional shape such as rectangle, circle, oval, triangle, polygon or other regular or irregular cross-sectional shape. In an example labeled as B, different perspective views of another implementation of a generally two-dimensional (2D) plate including a periodic, uniform array of equal-sized, pillars disposed on two sides/surfaces (e.g., top and bottom surfaces) of the plate is shown. In this implementation, the size of the pillars on a first side of the plate (e.g., top pillars) could be equal to or different than the size of the pillars on a second side of the plate (e.g., bottom pillars). In addition, although the pillars are shown in example B to have a square cross-section, they can have any other cross-sectional shape such as rectangle, circle, oval, triangle, polygon or other regular or irregular cross-sectional shape. In an example labeled as C, for example, different perspective views of another implementation of a generally two-dimensional (2D) plate with a periodic array of equal-sized pillars disposed on a first surface of the plate (e.g., on a top surface) with an empty row appearing every n number of rows (e.g., every third row in the implementation shown in FIG. 7, example C). Other distributions of full and empty rows, and columns, could also be employed. In an example labeled as D in FIG. 7 different perspective views of another implementation of a generally two-dimensional plate with a periodic array based on a multi-pillared unit cell having pillars with different heights is shown. In the particular example, each repeated unit cell has multiple pillars each of a different height but the same cross-sectional area and/or shape. In a different implementation, each repeated unit cell could have multiple pillars of different heights and also different cross-sectional areas. While in this configuration, there are four pillars in each unit cell, other configurations could include a larger or smaller number of pillars per unit cell, distributed on only one side or both sides of the thin film. different perspectives of a fifth implementation of a generally two-dimensional plate with a periodic array based on a multi-pillared unit cell having pillars with different cross-sectional areas. In the particular example labeled as E in FIG. 7, for example, each repeated unit cell has multiple pillars each of a different cross-sectional area but the same height and/or shape. In a different implementation, each repeated unit cell could have multiple pillars of different cross-sectional areas and also different heights and/or shapes. While in this configuration, there are four pillars in each unit cell, other configurations could include a larger or smaller number of pillars per unit cell.

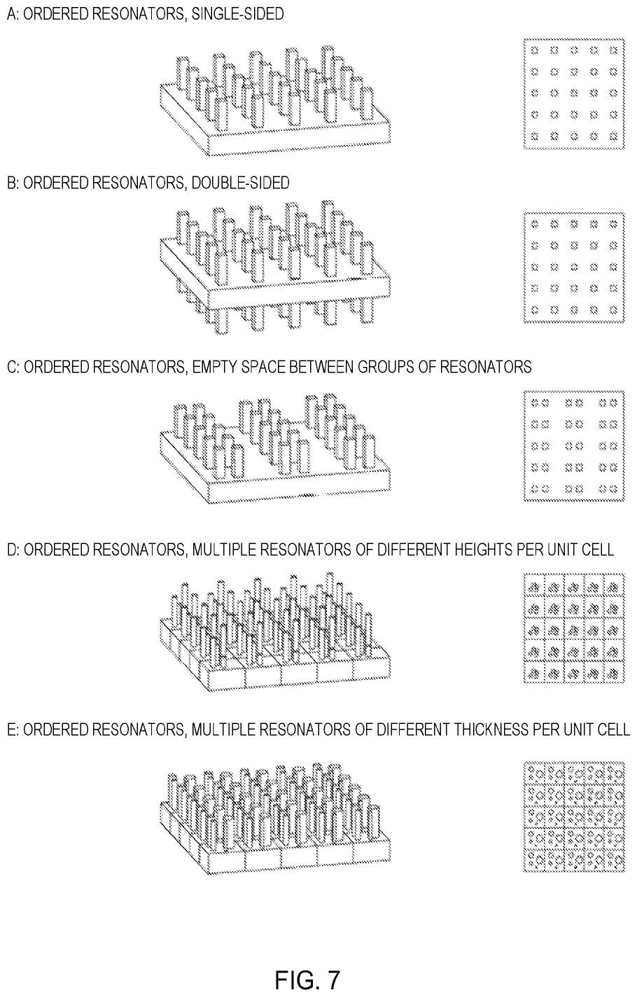

FIG. 8 depicts a plurality of example configurations of two-dimensional elastic metamaterials with one-dimensional locally resonant oscillators extending from a base material. These configurations may be used to form a phononic subsurface where the plates, where appropriate, may be oriented either in parallel or perpendicular or at an angle to the surface (and to the flow).

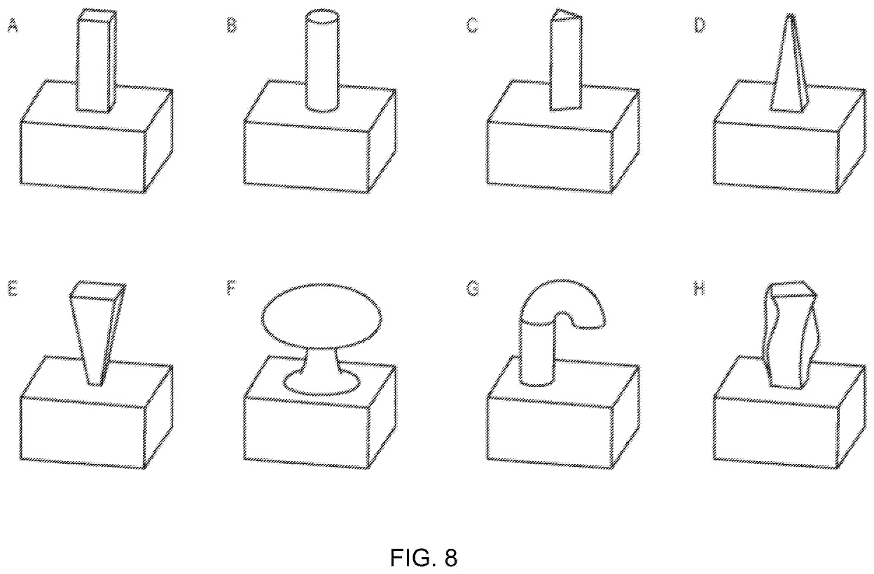

FIGS. 9A-9F depict a plurality of example configurations of one-dimensional locally resonant oscillator geometries/shapes that extend from a base material (as shown in FIG. 5).

FIG. 9A shows different perspective views of a sixth implementation of a generally two-dimensional (2D) plate including a two-dimensional (2D) periodic array of pillars disposed on a first and second surface of the plate (e.g., on a top surface and a bottom surface of the plate) in which a thickness (e.g., diameter) of the pillars vary randomly across different locations on the surface of the plate. In this implementation, the pillars on each side have same height, and the height of each pillar at the top is different than at the bottom. In another implementation, the height of each pillar at the top could be the same as at the bottom. Although pillars are shown on two sides in FIG. 9A, another implementation may have a similar configuration of pillars but on a single side only.

FIG. 9B shows different perspective views of a seventh implementation of a generally two-dimensional (2D) plate including a two-dimensional (2D) periodic array of pillars disposed on a first and second surface of the plate (e.g., on a top surface and a bottom surface of the plate) in which a height of the pillars vary randomly across different locations on the surface of the plate. In this implementation, the pillars on each side have the same thickness (e.g., diameter), and the thickness of each pillar at the top is the same than at the bottom. In another implementation, the thickness of each pillar at the top could be different than at the bottom. Although pillars are shown on two sides in FIG. 9A, another implementation may have a similar configuration of pillars but on a single side only.

FIG. 9C shows different perspective views of an eighth implementation of a generally two-dimensional (2D) plate including pillars disposed on a single surface (e.g., on a top surface) and whose positions and heights are random while their thicknesses are all the same. Although pillars are shown on a single side in FIG. 9C, another implementation may have a similar configuration of pillars but on two surfaces of a plate.

FIG. 9D shows different perspective views of an ninth implementation of a generally two-dimensional (2D) plate including pillars disposed on a single surface (e.g., on a top surface) and whose positions and thicknesses are random while their heights are all the same Although pillars are shown on a single side in FIG. 9D, another implementation may have a similar configuration of pillars but on two surfaces of a plate.

FIG. 9E shows different perspective views of a tenth implementation of a generally two-dimensional plate including a random (i.e., non-periodic) array of pillars on a single surface (e.g., on a top surface) with the thickness (e.g., diameter), shapes and heights of the pillars varying randomly across the different sites. Although pillars are shown on a single side in FIG. 9E, another implementation may have a similar configuration of pillars but on two surfaces of a plate.

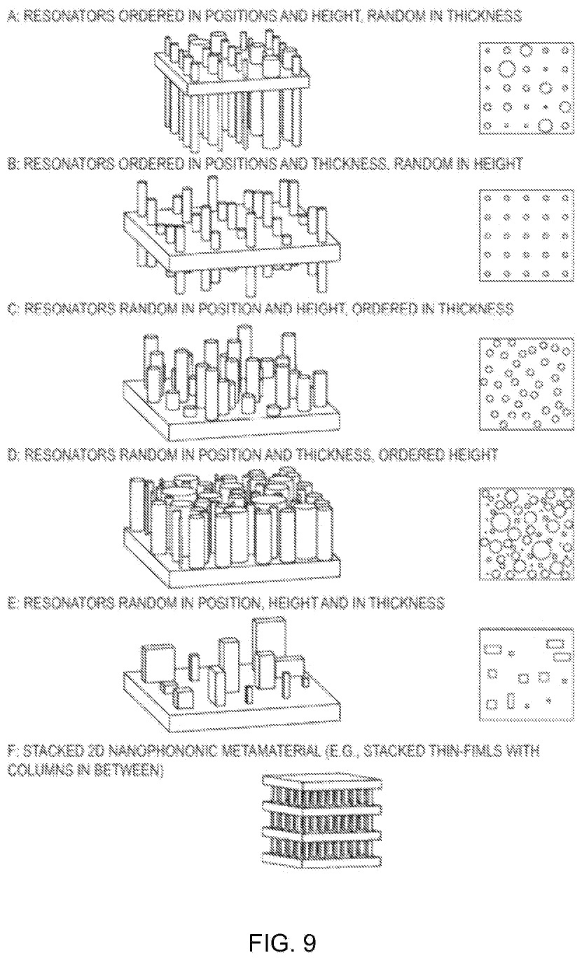

FIG. 9F shows a configuration of an eleventh implementation based on a vertical stacking of the of the pillared plate shown in FIG. 7A. The different features shown in other figures such as pillar spacing (see, for example, FIG. 7C), multi-pillar unit cell (see, for example, FIGS. 7D and 7E), walled configuration (see, for example, FIGS. 11A and 11B and their corresponding descriptions) and random pillars (see, for example, FIGS. 9A and 9D) may also apply to this vertical stacking configuration. While the figure shows, as an example three layers of pillared thin films stacked on top of each other, the number of layers of pillared thin films stacked could vary.

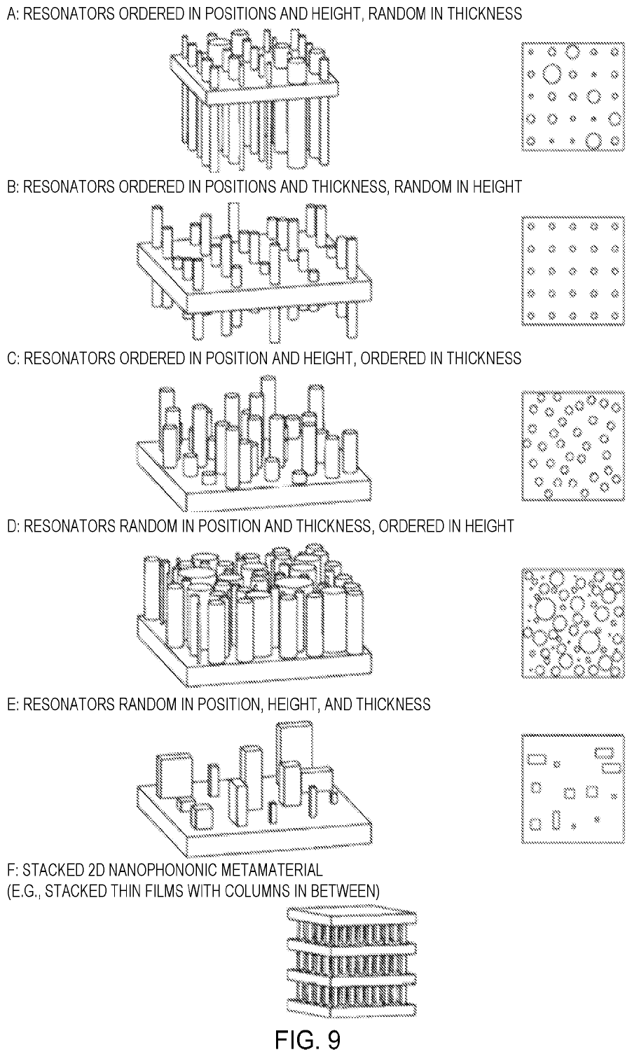

FIGS. 10A and 10B depicts other example configurations of two-dimensional elastic metamaterials with one-dimensional locally resonant oscillators extending from a base material—these configurations may be used to form a phononic subsurface where the plates, where appropriate, may be oriented either in parallel or perpendicular or at an angle to the surface (and to the flow). In a first example in FIG. 10A, different perspective views of another implementation of a generally two-dimensional plate including a bridged structure having a central cylinder supported by thin arms (e.g., beams) are shown. In this implementation, for example, the unit cell may be repeated to form a periodic or non-periodic array. The central cylinder (which could be of the same material as the main body of the thin film, or a heavier material) acts as a local oscillator/resonator in this configuration. Other shapes for oscillators/resonators in this configuration (e.g., square cylinder, sphere, others) may be employed, and the supporting arms also could have other shapes, number and orientations. This configuration concept could also be realized in the form of a 2D thick plate-like material with each oscillator/resonator taking the shape of a cylinder, or sphere or other shape.

In another shown in FIG. 10B, different perspective views of yet another implementation of a generally two-dimensional plate with a periodic array of circular inclusions comprising a highly complaint material (i.e., a material that is significantly less stiff than the material from which the main body of the thin film is made). In this particular implementation, for example, each inclusion of a compliant material in this configuration may act as an oscillator/resonator (i.e., similar to each pillar in FIG. 7A). Other shapes and sizes for the inclusions may also be adopted. The sites of the compliant inclusions may be ordered in a periodic fashion (as shown) or may be randomly distributed (as in FIGS. 9C and 9D). Similarly, the size of each inclusion may be uniform or may vary in groups (as in FIGS. 7D and 7E) or vary randomly.

FIGS. 11A and 11B depict yet other example configurations of two-dimensional elastic metamaterials with embedded resonant oscillators—these configurations may be used to form a phononic subsurface where the plates, where appropriate, may be oriented either in parallel or perpendicular or at an angle to the surface (and to the flow). FIG. 11A shows different perspective views of a fourteenth implementation of a generally two-dimensional (2D) plate including a one-dimensional (1D) periodic array of equal-sized walls disposed on a first surface of the plate (e.g., a top surface of the plate). In this particular implementation, each wall acts as an oscillator/resonator representing a 2D version of a pillar. The walls have a uniform cross section along the length, but other configurations could have a periodically or non-periodically varying cross-section along the length of the wall. Although walls are shown on a single side in FIG. 11A, another implementation may have a similar configuration of walls but on two surfaces of a plate.

FIG. 11B shows different perspective views of a fifteenth implementation of a generally two-dimensional (2D) plate including a two-dimensional (2D) periodic array of equal-sized or different sized walls disposed on a first surface of the plate (e.g., a top surface of the plate). In this particular implementation, each wall acts as an oscillator/resonator representing a 2D version of a pillar. Each wall has a uniform cross section along the length, but other configurations could have a periodically or non-periodically varying cross-section along the length of each wall. The thickness of the vertical walls could be different than the thickness of the horizontal walls. Although walls are shown on a single side in FIG. 11B, another implementation may have a similar configuration of walls but on two surfaces of a plate.

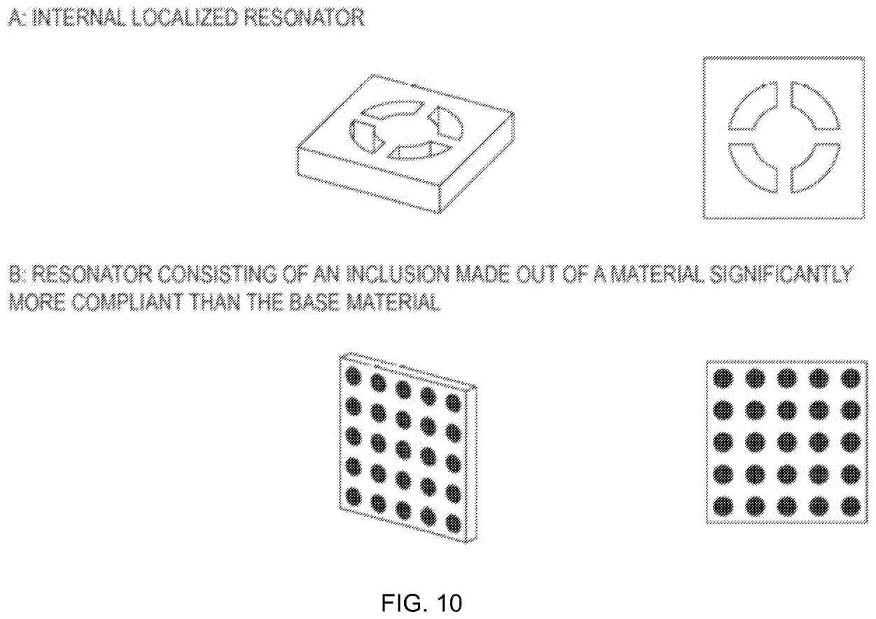

FIGS. 12A and 12B depict other example configurations of two-dimensional elastic metamaterials with two-dimensional locally resonant oscillators extending from a base material. These configurations may be used to form a phononic subsurface where the plates, where appropriate, may be oriented either in parallel or perpendicular or at an angle to the surface (and to the flow). FIG. 12A show different perspective views of a sixteenth implementation of a generally one-dimensional (1D) wire, rod, column or beam medium including a cyclic periodic array of equal-sized pillars disposed along the circumference of the main body medium. In this particular implementation, each pillar acts as an oscillator/resonator. In other implementations, the pillars may have other shapes. While in this configuration, eight pillars protrude at each lattice site, other configurations could include a larger or smaller number of pillars per lattice site.

FIG. 12B show different perspective views of a seventeenth implementation of a generally one-dimensional (1D) wire, rod, column or beam medium including a cyclic distribution of pillars of different heights disposed along the circumference of the main body medium. In this particular implementation, each pillar acts as an oscillator/resonator. In other implementations, the pillars may have other shapes. While in this configuration, four pillars protrude at each lattice site, other configurations could include a larger or smaller number of pillars per lattice site. Furthermore, in other implementations, the radial distribution of the pillars could be random. Furthermore, in other implementations, the heights of the pillars and/or shapes and/or thicknesses could be random along both the radial and axial directions.

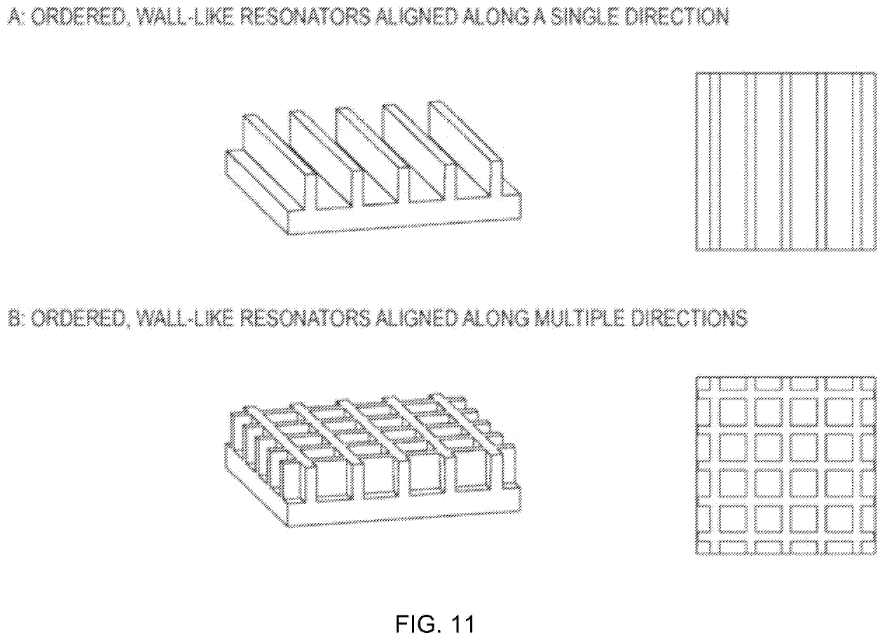

FIGS. 13A and 13B depict yet other example one-dimensional elastic metamaterials with one-dimensional locally resonant oscillators extending from a base material. These configurations may be used to form a phononic subsurface where the rods may be oriented perpendicular or at angle to the surface (and to the flow), similar to the relative orientation between the flow and the phononic material shown in FIGS. 1, 2, 4A, B. FIG. 13A shows different perspective views of another implementation of a generally one-dimensional (1D) wire, rod, column or beam medium including a one-dimensional (1D) periodic array of cylinders disposed along the axis of the main body medium. In this particular implementation, each cylinder acts as an oscillator/resonator. In other implementations, the cylinders may have other shapes.

FIG. 13B show different perspective views of a nineteenth implementation of a generally one-dimensional (1D) wire, rod, column or beam medium including a one-dimensional (1D) periodic array where each unit cell consists of multiple cylinders of different diameters and/or thicknesses disposed along the along the axis of the main body medium. In this particular implementation, each cylinder acts as an oscillator/resonator. In other implementations, the cylinders may have other shapes. While in this configuration, there are three cylinders in each unit cell, other configurations could include a larger or smaller number of cylinders per unit cell. Furthermore, in other implementations, the size, shape and positioning of the cylinders along the axis of the main body may be random.

FIG. 8 shows a variety of shapes and designs for a pillar. Any of these designs, or other shapes that would allow the pillar to function as an oscillator/resonator, may be applied in conjunction with the numerous design concepts/features shown FIGS. 4, 6 and 9.

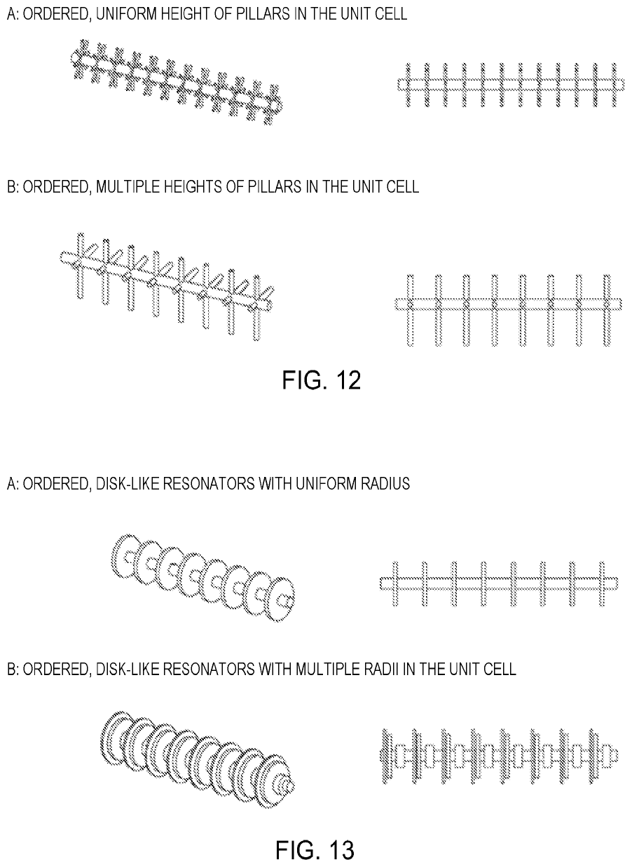

FIGS. 14A and 14B depict yet other example configurations of three-dimensional elastic metamaterials with embedded resonant oscillators. In various implementations, these configurations may be used to form a phononic subsurface where the periodic features may be oriented in any direction with respect to the surface (and the flow). FIG. 14A shows different perspective views of yet another implementation of a 3D material configuration including a bridged structure having a central sphere supported by thin arms (e.g., beams). In this implementation, for example, the unit cell may be repeated to form a periodic or non-periodic array. The central sphere (which could be of the same material as the main body of the thin film, or a heavier material) acts as a local oscillator/resonator in this configuration. Other shapes for oscillators/resonators in this configuration (e.g., cubic sphere, cylinder, others) may be employed, and the supporting arms also could have other shapes, number and orientations. In analogy to the configuration shown in FIG. 14A (which is a 2D version), the sites of the local resonators may be ordered in a periodic fashion (as shown) or may be randomly distributed.

FIG. 14B shows a 3D material configuration with a periodic array of cubic inclusions comprising a highly complaint material (i.e., a material that is significantly less stiff than the material from which the main body is made). The compliant material in this configuration acts as an oscillator/resonator (i.e., similar to the pillars in FIG. 7A). Other shapes for the inclusions may be adopted. In analogy to the configuration shown in FIG. 10B (which is a 2D version of FIG. 14B), the sites of the compliant inclusions may be ordered in a periodic fashion (as shown) or may be randomly distributed. Similarly, the size of each inclusion may be uniform or may vary in groups or vary randomly.

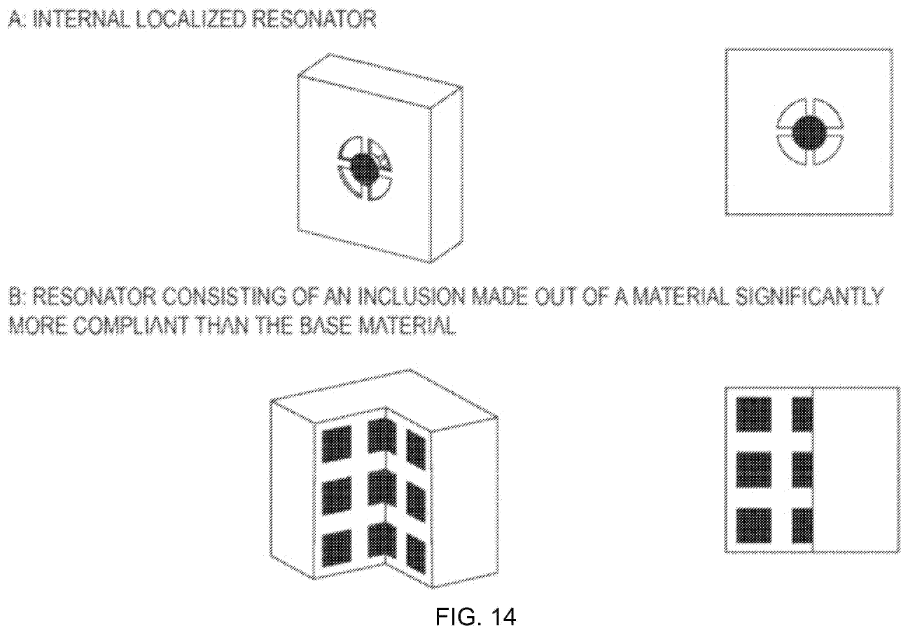

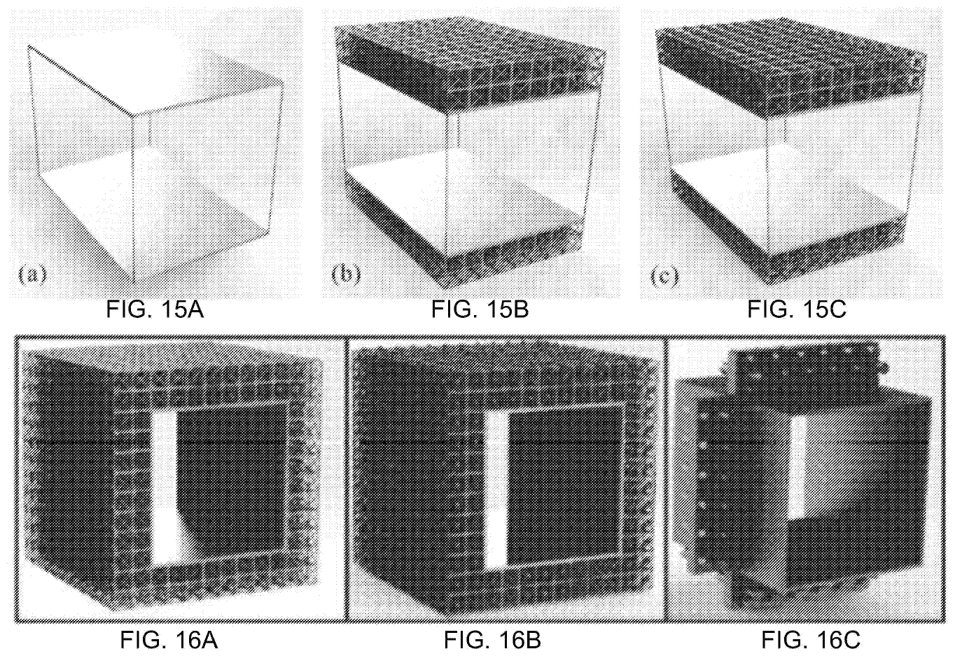

FIGS. 15, 16A, and 16B further show examples of phononic materials comprising lattice structures. The lattice structures, in these embodiments comprise a plurality of structural elements (e.g., beams, rods, bars, etc.) and voids/holes, and in some cases added masses to invoke local resonances. The lattice structure disposed adjacent the flow exhibits band gaps for interacting with the flow. The structural elements and voids may comprise a fully or partially periodic phononic material.

In various implementations, phononic materials are used in or adjacent to a surface that interacts with a fluid (i.e., liquid and/or gas and/or flowing solid) flow. As described above, phononic materials refer to phononic crystals and/or locally resonant metamaterials. Phononic crystals, which are spatially periodic, include materials designed based on the Bragg scattering principle. Locally resonant metamaterials, which are not necessarily spatially periodic, include those that work on the principle of internal resonances and mode hybridization. The concept comprises the introduction of an elastic medium (e.g., a phononic crystal and/or locally resonant metamaterial), located at one or more points or regions of interest along a surface, and, in one implementation, extending in a manner such that its spatial periodicity (or generally the direction of elastic wave propagation) is along a depth, e.g., at least generally perpendicular or at an angle to the surface, at least generally along the surface or both. The terms one-dimensional (1D), two-dimensional (2D) and three-dimensional (3D) are used herein to describe both the characteristics of various base material configurations as well as the shape, size, orientation, material composition and/or location/distribution of material/geometrical interfaces or local oscillators/resonators in a locally resonant metamaterial. A base material, for example, may be described as a one-dimensional (1D) base material in the shape of a wire or rod or column that extends, with the exception of other dimensions, in a generally single dimension. Similarly, a base material, such as a thin-film/membrane/sheet or plate-shaped base material may be described as a two-dimensional (2D) structure, with the exception of other dimensions, that extends in two dimensions. Also, a different base material, such as a bulk material, may be described as a three-dimensional (3D) base material. Similarly, local oscillators/resonators, such as pillars shown in FIG. 7 may also be described with respect to one-, two- or three-dimensional structures as described herein with reference to those figures.

In one implementation, lattice phononic subsurfaces in the form of pillars are positioned periodically along one or both free surfaces of a plate base material. While the pillars in principle need not be arranged periodically for the hybridization effect to take root (the relaxation of the periodicity requirement is an advantage from the point of view of design/fabrication flexibility and insensitivity to geometric variations), the periodic positioning of the pillars in this particular implementation (1) provides an efficient way to compactly arrange the pillars, (2) allows for a systematic way to theoretically analyze, assess and design the locally resonant metamaterial, and (3) provides an additional mechanism for control of interface phasing and amplitude, namely, by Bragg scattering.

In another implementation, multiple lattice phononic subsurfaces pillar local oscillators/resonators are used on one or both free surfaces of a base thin-film material with each including a unique (distinct) height and/or cross-sectional area (see, for example, FIG. 6). In this implementation, utilization of multiple pillars (above and/or below the thin film), each of which has a distinct geometrical dimension (in terms of the height and/or the cross-sectional area) provides multiple distinct resonance sets, and the more resonant sets the more couplings/hybridizations/interactions that take place across the spectrum and this in turn leads to a richer design space for the performance metric.

One example implementation is shown in FIGS. 4A and 4B in which a segment of a bottom surface of a flow channel with otherwise all-rigid walls is replaced with a 1D lattice phononic subsurface material. In this particular implementation, the flow channel comprises a plurality of walls, such as the four walls shown, and having a generally rectangular cross-section. In other implementations, the flow channel may comprise any shape such as having a generally circular, elliptical, square, polygon or other cross-section. The flow channel may also include varying dimensions, such as a narrowing or expanding flow channel.

In the implementation shown in FIGS. 1, 2, 4A, and 4B, for example, a flow direction of a fluid flowing through the flow channel flows in a first direction as shown by the arrow. The 406 flow channel includes a plurality of rigid surfaces defining the flow channel disposed within an inner boundary formed by the rigid surfaces. In one or more locations the rigid surface is replaced by the 1D elastic phononic crystal as shown in FIG. 1. In this implementation, the 1D lattice phononic subsurface material includes a plurality of unit cells each of length a disposed in a stacked configuration extending in a depth direction, d, which in this implementation is generally perpendicular to a rigid surface of the flow channel along which a fluid flows in the flow channel.

A single unit cell of the lattice phononic subsurface structure, in this implementation comprises a first layer and a second layer of different Young's modulus, density and layer thickness disposed adjacent to each other. In one example implementation, for example, the first layer may include a polymer, such as ABS, and the second layer may include a metal material, such as aluminum. However, these are merely examples and other materials are contemplated.

In another example implementation, FIGS. 4A and 4B includes a flow channel implementation in which a surface of a flow channel (e.g., the bottom surface shown in FIG. 1) includes a flexible material that may move in response to a pressure exerted on the surface by a fluid flowing in the flow channel. A 1D lattice phononic subsurface material is disposed outside the flexible surface of the flow channel. Movement of the flexible surface correspondingly causes movement in an interface surface of lattice phononic subsurface material.

In this particular implementation, the flow channel comprises a plurality of walls, such as the four walls shown, and having a generally rectangular cross-section. In other implementations, the flow channel may comprise any shape such as having a generally circular, elliptical, square, polygon or other cross-section. The flow channel may also include varying dimensions, such as a narrowing or expanding flow channel.

In the implementation shown in FIG. 1, for example, a flow direction of a fluid flowing through the flow channel flows in a first direction as shown by the arrow. A Tollmien-Schlichting (TS) wave propagates through the flow channel in the first direction. The flow channel includes a plurality of surfaces defining the flow channel disposed within an inner boundary formed by the surfaces. In this implementation, at least one of the surfaces comprises a flexible surface that interacts with the 1D lattice phononic subsurface material as shown in FIGS. 4A and 4B. In this implementation, the one-dimensional lattice phononic subsurface material includes a plurality of unit cells each of length a disposed in a stacked configuration extending in a depth direction, d, which in this implementation is generally perpendicular to a rigid surface of the flow channel along which a fluid flows in the flow channel.

A single unit cell of the lattice phononic subsurface material, in this implementation again comprises a first layer and a second layer of different Young's modulus, density and layer thickness disposed adjacent to each other. In one example implementation, for example, the first layer may include a polymer, such as ABS, and the second layer may include a metal material, such as aluminum. However, these are merely examples and other materials are contemplated.

The lattice phononic subsurface material(s) interact with and alter phasing of waves in the flow. The interactions, for example, may increase stability and/or instability in the flow depending upon design. Phononic materials and structures including phononic materials may be designed and constructed utilizing fundamental concepts from phonon physics including Bragg scattering and internal resonances (separately or in combination) to form a band structure in their frequency responses, comprising stop bands (also known as band gaps) and pass bands (also known as bands). The band structure, for example, may form stop bands to induce “out-of phasing” and, conversely, pass-bands to induce “in-phasing” in the interacting fluid flow (gases and liquids, single phase and multi-phase), as well as in flowing solids like ice and snow, that are in contact directly with the phononic material(s) or indirectly when the phononic material(s) is/are located behind a flexible substrate/surface skin for the purpose of flow control. When a phononic material(s) is laid out in a manner adjacent to a surface (for example, underneath or behind a surface), the present application refers to it as a “phononic subsurface.” The stop-bands and pass-bands, along with the structural resonance characteristics, can also be designed to enhance and/or absorb energy in the fluids, enhance or reduce lift, advance or delay separation, alter heat transfer, reduce or enhance flutter or increase or decrease turbulence.

Example tenets pertaining to the theory/technique are described in Hussein M I, Biringen S, Bilal O R, Kucala, A. Flow stabilization by subsurface phonons. Proc. R. Soc. A 471: 20140928 and in further detail below.

Designing a lattice phononic subsurface material can be performed such that its phase relation is negative at the frequency of the flow wave in order to induce stabilization, or positive at that frequency in order to induce destabilization. This phase relation may be obtained, for example, by simulating vibrations in the phononic material in a separate ‘offline’ calculation, with identical boundary conditions to the planned coupled fluid/structure configuration, and correlating between the phase of the excitation and that of the response at the part of the lattice phononic subsurface material or structure that will be exposed to the flow, which is the interface or surface. This correlation can be taken (integrated) over an extended scan of time in order to ensure a steady state representation of the strength (positive or negative) of the frequency-dependent phase function.

The response amplitude of the interface or surface, or in general the part of the material that will be exposed to the flow, can be designed to be as high as possible (e.g., within a realm of small, infinitesimal vibrations) at the frequency of a flow wave (or spectra of waves) of interest in order for the out-of-phasing or in-phasing effects mentioned above to take effect.

In order to combine both the phase and amplitude effects together, a ‘performance metric’ may be devised that is the product of these two frequency-dependent quantities, the phase and the amplitude. At the frequency of the flow wave, the following results are expected:
High absolute value of negative performance metric—strong stabilization
Low absolute value of negative performance metric—weak stabilization
High absolute value of positive performance metric—strong destabilization
Low absolute value of positive performance metric—weak destabilization

Since the lattice phononic subsurface material is finite in length, a truncation (local surface) mode/resonance appears in the spectrum and tends to fall within a stop band. The performance metric is negative to the right of this resonance and therefore the phononic subsurface unit cell may be designed such that this truncation resonance falls to the left of the frequency of the flow wave (or spectra of waves) that is to be stabilized.

Within a pass band, the performance metric oscillates between positive and negative across frequency windows bounded by the finite structure's resonances and antiresonances.

All the points made above for controlling a single flow wave at a particular frequency may be repeated for other flow waves with other frequencies appearing within the flow. One way to implement this multi-frequency strategy is to assemble a stack of lattice subsurface phononic material next to each other, where each lattice phononic subsurface material is designed to cover a particular frequency.

In principle, the structure used to control the flow may be a standard homogenous and uniform elastic structure for which a performance metric can similarly be used to guide the design. An advantage of using a lattice phononic subsurface material, however, is that it is based on intrinsic unit-cell properties and is thus more robust to any changes to the boundary conditions during operation.

Control of flow propagation or properties, for example, may increase wave stability and/or instability depending on design characteristics. For example, stabilization may be accomplished or at least increased within a stop band (or more than one stop band) by inducing destructive interferences in the velocity and/or pressure fields of a flow that lead to attenuation of wave amplitudes (e.g., disturbance/instability wave amplitudes) in the flow at frequencies for which the performance metric is negative. Similarly, flow destabilization may be induced within a pass band (or more than one pass band) by constructive interferences in the velocity and/or pressure fields of a flow that amplify wave amplitudes (e.g., disturbance/instability wave amplitudes) in the flow at frequencies for which the performance metric is positive. Flow destabilization may also occur within a stop band at a frequency falling to the left of the truncation resonance frequency.

In one implementation, for example, a lattice phononic subsurface material may be designed to stabilize an unstable wave at a particular frequency as follows. A unit cell of a lattice phononic subsurface material is designed and optimized to exhibit a stop band (band-gap) encompassing, or at least partially encompassing, the frequency of an instability wave or the range of frequencies of several instability waves. A steady-state frequency response analysis may also be conducted on a model. The steady state frequency response analysis, for example, may include representing a finite structure composed of one or more unit cells of the type designed above. The unit cells may be laid out in a direction perpendicular, at an angle, parallel, or a combination thereof, to the surface (and flow). The unit cell and possibly the end design and boundary conditions of the structure may be altered until a periodicity truncation resonance (or more than one periodicity truncation resonance) that is closest to the instability wave frequency is (are) located as close as possible (or at least reasonably close to) and at least partially to the left of the instability wave frequency. A performance metric may be used to evaluate the predicted performance of the lattice phononic subsurface material as explained in Hussein M I, Biringen S, Bilal O R, Kucala, A. Flow stabilization by subsurface phonons. Proc. R. Soc. A 471: 20140928, which is hereby incorporated by reference in its entirety as if fully set forth herein. The process may be repeated until the predicted performance metric gives a negative value with the highest possible absolute value or at least a significant stabilizing effect.

One advantage of this example approach is that a lattice phononic subsurface material can be fully designed without carrying out any coupled fluid-structure simulations (which tend to be computationally expensive). However, a fluid-structure simulation may be conducted as a verification, especially to ensure that the level of damping (material and structural) in the phononic subsurface is optimal or at least satisfactory for a particular application.

The same process as the one mentioned above may be similarly adopted for destabilization, with the exception that (1) the unit cell in this case is designed to exhibit a pass band around the frequency of interest and (2) the structure overall (including the unit cell layout) is designed such that the frequency of interest matches, or at least overlaps with, a pass-band resonance frequency.

While the above descriptions are concerned with the manipulation of a single frequency (unstable wave for stabilization or vice versa), the methodology can be extended to cover particular frequencies simultaneously and their harmonics (which is relevant to nonlinear instabilities and transition control) and a range of frequencies (which is relevant to turbulence and turbulent flow control).

In one implementation of a flow-related system, for example, one or more lattice phononic subsurface material structures may be designed to control a transition of a fluid from a laminar flow to a turbulent flow. The transition from a laminar flow to a turbulent flow can be delayed by increasing the stability of the flow. Similarly, the transition of the laminar flow to a turbulent flow may be controlled to be earlier than would otherwise be achieved by decreasing the stability of the flow.

FIG. 5A depicts example dispersion curves for a one-dimensional layered phononic crystal from which the subsurface is composed (Brillouin zone illustrated in inset). FIG. 5B depicts an example steady-state vibration response of the phononic crystal surface representing the interface with the flow as shown in FIGS. 1, 2, 4A, and 4B. FIG. 2C depicts an example time-averaged phase between force and displacement at the phononic crystal surface representing the interface with the flow as shown in FIGS. 1, 2, 4A, and 4B. FIG. 5D depicts an example performance metric combining amplitude and relative phase between the force and the displacement at the phononic crystal surface representing the interface with the flow as shown in FIGS. 1, 2, 4A, and 4B. In FIGS. 5B-5D, results obtained by analyzing the phononic crystal alone (without coupling to the flow) are represented by black solid curves. Results from the coupled fluid-structure simulations are represented by dots. In FIG. 5B, the four coupled simulation data points are all multiplied by a single common constant to calibrate with the uncoupled model curve. In one implementation, a lattice phononic subsurface material comprises a lattice structure comprising a plurality of structural elements (e.g., beams, rods, etc.) and voids/holes. The lattice structure disposed adjacent the flow exhibits band gaps for interacting with the flow.

FIGS. 15 and 16 shows example lattice configurations that may be used in a lattice phononic subsurface material such as described herein. In each example configuration, the lattice phononic subsurface material comprises a plurality of structural elements and voids disposed within the phononic subsurface material. The lattice subsurface material may further include a solid surface material disposed adjacent a flow and/or may be disposed adjacent to a flow surface disposed adjacent the flow such as described herein.

In various embodiments, the lattice phononic subsurface material including a lattice structure may comprise a 1D, 2D or 3D structure. A lattice structure phononic may comprise 1D Timoshenko beam structures and voids or other structures. A 2D lattice structure may comprise a triangular honeycomb lattice and, in various implementations, may exhibit bandgaps between relatively low branches.

The lattice structures provide for decreased weight within the phononic subsurface material compared to a similarly arranged solid phononic subsurface material. Further, the presence of the structural elements and the voids provide a response to waves within the flow similar to a relatively deeper solid phononic subsurface material.

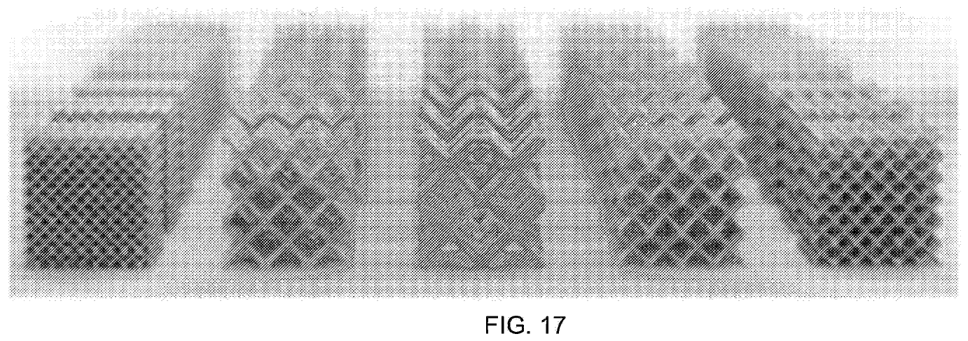

FIG. 17 shows further example 3D lattice structured phononic materials that may be used a phononic subsurfaces as described herein.

In various examples, a material for use in interacting with a hypersonic flow and a method of interacting with a hypersonic flow using such a material are provided.

In one implementation, for example, a material is provided for use in interacting with a hypersonic flow. In this example implementation, the material comprises an interface surface and a subsurface feature extending from the interface surface. The interface surface is adapted to move in response to a pressure associated with at least one mode of instability of at least one wave in a hypersonic flow exerted on the interface surface. The subsurface feature comprises a phononic crystal or locally resonant metamaterial adapted to receive the at least one wave having the at least one frequency based upon the pressure from the flow via the interface surface and alter a phase of the at least one wave. The interface surface is adapted to vibrate at a frequency, phase, and amplitude in response to the altered phase of the at least one wave, and by suppressing the at least one mode to prevent or reduce a temperature rise at the interface surface.

In another implementation, a material for use in interacting with a fluid or solid flow is provided. In this example implementation, the material comprises an interface surface and a subsurface feature extending from the interface surface. The interface surface comprises a high-temperature-resistant material adapted to move in response to a pressure associated with at least one wave in a flow exerted on the interface surface. The subsurface feature comprises a phononic crystal or locally resonant metamaterial adapted to receive the at least one wave having the at least one frequency based upon the pressure from the flow via the interface surface and alter a phase of the at least one wave. The interface surface is adapted to vibrate at a frequency, phase, and amplitude in response to the altered phase of the at least one wave. The subsurface feature comprises at least one of titanium and a high-temperature resistant material or a high-temperature resistant composite material.

### Combination of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A phononic material includes an interface surface and a subsurface feature mechanically connected to the interface surface. The interface surface vibrates in response to one or more frequency components of a pressure exerted thereon by a hypersonic flow having at least one instability. The interface surface couples the one or more frequency components into the subsurface feature. The subsurface feature at least partially reflects and phase-shifts each of the one or more frequency components to generate a phase-shifted frequency component. The interface surface vibrates in response to the phase-shifted frequency component to couple the phase-shifted frequency component into the hypersonic flow. The phase-shifted frequency component interferes with said each of the one or more frequency components within the hypersonic flow.

(A2) In the phononic material denoted (A1), the at least one instability includes one or more of: a first order instability, a second order instability, Görtler instability, and a crossflow instability.

(A3) In either of the phononic materials denoted (A1) and (A2), the hypersonic flow comprises a laminar flow or a transitional flow.

(A4) In any of the phononic materials denoted (A1)-(A3), the phase-shifted frequency component destructively interferes with said each of the one or more frequency components to reduce the at least one instability.

(A5) In any of the phononic materials denoted (A1)-(A3), the phase-shifted frequency component constructively interferes with said each of the one or more frequency components to increase the at least one instability.

(A6) In any of the phononic materials denoted (A1)-(A5), the subsurface feature is one of a phononic crystal, an elastic metamaterial, and a periodic structure.

(A7) In any of the phononic materials denoted (A1)-(A6), the subsurface feature includes a plurality of layers. The interface surface is an initial layer of the plurality of layers that is closest to the hypersonic flow.

(A8) In any of the phononic materials denoted (A1)-(A7), the interface surface directly contacts the hypersonic flow. Here, “directly” means without any intervening material or physical component.

(A9) In any of the phononic materials denoted (A1)-(A8), the interface surface contacts an outer wall of a fluid channel within which the hypersonic flow passes.

(A10) In any of the phononic materials denoted (A1)-(A9), the subsurface feature comprises a titanium sub-lattice structure.

(A11) In any of the phononic materials denoted (A1)-(A10), the subsurface feature comprises a C—SiC or SiC—SiC composite material.

(A12) In any of the phononic materials denoted (A1)-(A11), the subsurface feature comprises a titanium cage with a triangular lattice network of beams.

(A13) In any of the phononic materials denoted (A1)-(A12), the subsurface feature comprises a lattice formed from one or more of a plurality of thin sheets, a plurality of plates, a plurality of rods, a plurality of beams, and a plurality of trusses.

(B1) A method for controlling a hypersonic flow that has at least one instability includes coupling, with the interface surface of any of the phononic materials denoted (A1)-(A13), one or more frequency components of a pressure of the hypersonic flow into the subsurface feature of the phononic material. The method also includes reflecting and phase-shifting, with the subsurface feature, each of the one or more frequency components to generate a phase-shifted frequency component. The method also includes coupling, with the interface surface, the phase-shifted frequency component into the hypersonic flow. The method also includes interfering the phase-shifted frequency component with said each of the one or more frequency components within the hypersonic flow.

(B2) In the method denoted (B1), the at least one instability includes one or more of: a first order instability, a second order instability, Görtler instability, and a crossflow instability.

(B3) In either of the methods denoted (B1) and (B2), said interfering includes destructively interfering the phase-shifted frequency component with said each of the one or more frequency components to reduce the at least one instability.

(B4) In either of the methods denoted (B1) and (B2), said interfering includes constructively interfering the phase-shifted frequency component constructively with said each of the one or more frequency components to increase the at least one instability.

(B5) In any of the methods denoted (B1)-(B4), the subsurface feature has a plurality of layers and the interface surface is an initial layer of the plurality of layers that is closest to the hypersonic flow. Said coupling the one or more frequency components includes coupling, with the initial layer, the one or more frequency components into the subsurface feature. Said coupling the phase-shifted frequency component includes coupling, with the initial layer, the phase-shifted frequency component into the hypersonic flow.

(B6) In any of the methods denoted (B1)-(B5), said reflecting and phase-shifting includes reflecting and phase-shifting with one of a phononic crystal, an elastic metamaterial, and a periodic structure.

(B7) In any of the methods denoted (B1)-(B6), the method further includes flowing the hypersonic flow such that the pressure couples to the interface surface.

What is claimed is:

1. A phononic material comprising:
an interface surface; and
a subsurface feature mechanically connected to the interface surface;
wherein:
the interface surface vibrates in response to one or more frequency components of a pressure exerted thereon by a hypersonic flow having at least one instability, the interface surface coupling the one or more frequency components into the subsurface feature;
the subsurface feature at least partially reflects and phase-shifts each of the one or more frequency components to generate a phase-shifted frequency component;
the interface surface vibrates in response to the phase-shifted frequency component to couple the phase-shifted frequency component into the hypersonic flow; and
the phase-shifted frequency component interferes with said each of the one or more frequency components within the hypersonic flow.

2. The phononic material of claim 1, wherein the at least one instability includes one or more of: a first order instability, a second order instability, Girder instability, and a crossflow instability.

3. The phononic material of claim 1, wherein the hypersonic flow comprises a laminar flow or a transitional flow.

4. The phononic material of claim 1, wherein the phase-shifted frequency component destructively interferes with said each of the one or more frequency components to reduce the at least one instability.

5. The phononic material of claim 1, wherein the phase-shifted frequency component constructively interferes with said each of the one or more frequency components to increase the at least one instability.

6. The phononic material of claim 1, wherein the subsurface feature is one of a phononic crystal, an elastic metamaterial, and a periodic structure.

7. The phononic material of claim 1, wherein:
the subsurface feature comprises a plurality of layers; and
the interface surface is an initial layer of the plurality of layers that is closest to the hypersonic flow.

8. The phononic material of claim 1, wherein the interface surface directly contacts the hypersonic flow.

9. The phononic material of claim 1, wherein the interface surface contacts an outer wall of a fluid channel within which the hypersonic flow passes.

10. The phononic material of claim 1, wherein the subsurface feature comprises a titanium sub-lattice structure.

11. The phononic material of claim 1, wherein the subsurface feature comprises a C—SiC or SiC—SiC composite material.

12. The phononic material of claim 1, wherein the subsurface feature comprises a titanium cage with a triangular lattice network of beams.

13. The phononic material of claim 1, wherein the subsurface feature comprises a lattice formed from one or more of a plurality of thin sheets, a plurality of plates, a plurality of rods, a plurality of beams, and a plurality of trusses.

14. A method for controlling a hypersonic flow that has at least one instability, comprising:
coupling, with the interface surface of the phononic material of claim 1, one or more frequency components of a pressure of the hypersonic flow into the subsurface feature of the phononic material;
reflecting and phase-shifting, with the subsurface feature, each of the one or more frequency components to generate a phase-shifted frequency component;
coupling, with the interface surface, the phase-shifted frequency component into the hypersonic flow; and
interfering the phase-shifted frequency component with said each of the one or more frequency components within the hypersonic flow.

15. The method of claim 14, wherein the at least one instability includes one or more of: a first order instability, a second order instability, Görtler instability, and a crossflow instability.

16. The method of claim 14, wherein said interfering includes destructively interfering the phase-shifted frequency component with said each of the one or more frequency components to reduce the at least one instability.

17. The method of claim 14, wherein said interfering includes constructively interfering the phase-shifted frequency component constructively with said each of the one or more frequency components to increase the at least one instability.

18. The method of claim 14, wherein:
the subsurface feature comprises a plurality of layers;
the interface surface is an initial layer of the plurality of layers that is closest to the hypersonic flow;
said coupling the one or more frequency components includes coupling, with the initial layer, the one or more frequency components into the subsurface feature; and
said coupling the phase-shifted frequency component includes coupling, with the initial layer, the phase-shifted frequency component into the hypersonic flow.

19. The method of claim 14, wherein said reflecting and phase-shifting includes reflecting and phase-shifting with one of a phononic crystal, an elastic metamaterial, and a periodic structure.

20. The method of claim 14, further comprising flowing the hypersonic flow such that the pressure couples to the interface surface.
